(19) United States
(12) Patent Application Publication
(10) Pub. No.: US 2018/0091979 A1
(43) Pub. Date: Mar. 29, 2018

(54) DATA TRANSMISSION METHOD AND DEVICE, AND OCCUPATION SIGNAL TRANSMISSION METHOD AND DEVICE

(71) Applicant: ZTE Corporation, Shenzhen (CN)

(72) Inventors: Ling YANG, Shenzhen (CN); Wei GOU, Shenzhen (CN); Yajun ZHAO, Shenzhen (CN); Feng BI, Shenzhen (CN)

(21) Appl. No.: 15/563,215

(22) PCT Filed: Mar. 18, 2016
(86) PCT No.: PCT/CN2016/076789

§ 371 Date: Sep. 29, 2017

(30) Foreign Application Priority Data
Mar. 30, 2015 (CN) 201510145303.7

(51) Int. Cl. H04W 16/14; H04W 74/08; H04W 72/04; H04L 5/00

(52) U.S. Cl. CPC H04W 16/14; H04L 5/0048; H04W 72/04; H04W 74/0808

(57) ABSTRACT

A data transmission method and device, and an occupation signal transmission method and device are provided. In the data transmission method, a first group of terminals and/or a second group of terminals perform Clear Channel Assessment (CCA) and/or evolved Clear Channel Assessment (eCCA) detection on unlicensed carrier bandwidth resources by using at least one of the following manners: the first group of terminals and/or the second group of terminals respectively perform CCA and/or eCCA detection on CCA and/or eCCA resources pre-configured for the first group of terminals and/or the second group of terminals; the first group of terminals and/or the second group of terminals respectively perform CCA and/or eCCA detection on the entire unlicensed carrier bandwidth resources; and the first group of terminals and/or the second group of terminals determine subsequent data transmission based on a detection result.

### TECHNICAL FIELD

The present disclosure relates to the field of communications, and more particularly to a data transmission method and device, and an occupation signal transmission method and device.

### BACKGROUND

With rapid increase of data services, a data transmission pressure exerted on a licensed carrier may also increase. Therefore, it may be worth considering that data traffic in a licensed carrier is shared by means of an unlicensed carrier.

The unlicensed carrier has the following characteristics.

1. The unlicensed carrier may be free or low-expense (it may be unnecessary to purchase an unlicensed spectrum, and spectrum resources may be zero-cost).

2. Both the access requirement and the cost may be low (both a person and an enterprise may participate in deployment of the unlicensed carrier, and equipment of an operator may be arbitrarily deployed).

3. An available bandwidth may be large (unlicensed bands such as 5 GHz and 2.4 GHz may be used).

4. Resources may be shared (when multiple different systems operate in the unlicensed carrier system or different operators of the same system operate in the unlicensed carrier system, some resource sharing manners may be taken into consideration for improving the spectrum efficiency).

5. There may be many radio access technologies (crossing different communication standards, thereby being difficult to cooperate and diversified in network topology).

6. There may be many radio access stations (large in user quantity, high in cooperation difficulty and large overhead of centralized management).

7. There may be many applications (multiple services may operate in the unlicensed carrier system, such as Machine to Machine (M2M) and Vehicle to Vehicle (V2V)).

In an evolution process of a Long-Term Evolution (LTE), a research on an LTE Rel-13 version had been launched since September, 2014. One of important contents of the LTE Rel-13 version is that the LTE system may work by using an unlicensed carrier. This technology may enable the LTE system to use the current unlicensed carrier, thereby greatly improving potential spectrum resources of the LTE system to enable the LTE system to obtain a lower spectrum cost.

However, for the situation that the LTE system and/or other systems work over an unlicensed spectrum, the LTE system has a mechanism for improving the resource acquisition probability by participation of a User Equipment (UE) side in contention for unlicensed carrier resources. On the basis of this mechanism, when detecting that a channel is clear by executing Clear Channel Assessment (CCA) detection, the UE may immediately transmit an occupation signal to a base station (e.g., an evolved NodeB, eNB). However, in this case, the following problems may exist. If detecting that a channel is clear by executing CCA, UE1 may transmit an occupation signal. When detecting that the channel is occupied by executing CCA, if UE2 does not identify and measure the occupation signal so that surrounding interference may be shielded, the overall performance of the system may be influenced due to serious interference caused by multi-user reuse data transmission in the same cell or different cells subordinate to the same operator. Moreover, the UE detects whether unlicensed carrier resources are clear on the entire unlicensed carrier resources, so the entire unlicensed carrier resources may only be used by UEs in the same cell or UEs in different cells subordinate to the same operator. Since available unlicensed carrier resources are limited, it may be thus concluded that the quantity of UEs capable of using the unlicensed carrier resources is also limited, and the reuse rate of the entire unlicensed carrier resources is relatively low.

Any effective solution has not been proposed yet at present for a problem of low reuse rate of resources.

### SUMMARY

Some embodiments of the present disclosure provide a data transmission method and device, and an occupation signal transmission method and device, which may at least solve a problem of low reuse rate of resources.

According to one embodiment of the present disclosure, a data transmission method is provided. The data transmission method may include the following acts. A first group of terminals and/or a second group of terminals may perform CCA and/or evolved CCA (eCCA) detection on unlicensed carrier bandwidth resources by using at least one of the following manners: the first group of terminals and/or the second group of terminals may respectively perform CCA and/or eCCA detection on CCA and/or eCCA resources pre-configured for the first group of terminals and/or the second group of terminals; the first group of terminals and/or the second group of terminals may respectively perform CCA and/or eCCA detection on entire unlicensed carrier bandwidth resources. In this embodiment, each group of the first group of terminals and/or the second group of terminals may include two or more terminals. The first group of terminals and/or the second group of terminals may determine subsequent data transmission based on a detection result.

In an exemplary embodiment, terminals in the first group of terminals may have at least one of the following characteristics: terminals in a same cell; terminals in different cells subordinate to a same operator; and UEs in different cells subordinate to different operators. In an exemplary embodiment, terminals in the second group of terminals may have at least one of the following characteristics: terminals in a same cell; terminals in different cells subordinate to a same operator; and UEs in different cells subordinate to different operators.

In an exemplary embodiment, the CCA and/or eCCA resources pre-configured for the first group of terminals and/or the second group of terminals may be configured by using at least one of the following manners. The CCA and/or eCCA resources may be configured by a base station. The CCA and/or eCCA resources are configured via a negotiation between the first group of terminals and the second group of terminals.

In an exemplary embodiment, after the first group of terminals and/or the second group of terminals respectively perform CCA and/or eCCA detection on the pre-configured CCA and/or eCCA resources, the method may further include the following acts. The first group of terminals and/or the second group of terminals may determine that a channel is clear. The first group of terminals and/or the second group of terminals may respectively transmit an occupation signal on unlicensed carrier bandwidth resources subjected to CCA and/or eCCA detection; or, the first group of terminals and/or the second group of terminals may respectively transmit an occupation signal on the entire unlicensed carrier bandwidth resources. The first group of terminals and/or the second group of terminals may determine subsequent data transmission based on the transmitted occupation signal.

In an exemplary embodiment, after the first group of terminals and/or the second group of terminals respectively perform CCA and/or eCCA detection on the entire unlicensed carrier bandwidth resources, the method may further include the following acts. The first group of terminals and/or the second group of terminals may detect that a channel is clear. After detecting that the channel is clear, the first group of terminals and/or the second group of terminals may respectively transmit an occupation signal on the entire unlicensed carrier bandwidth resources; or, after detecting that the channel is clear, the first group of terminals may transmit an occupation signal on the entire unlicensed carrier bandwidth resources, and when detecting that the channel is not clear, the second group of terminals may receive and parse the occupation signal transmitted by the first group of terminals.

In an exemplary embodiment, the occupation signal transmitted by the first group of terminals and/or the second group of terminals may carry at least one of a group identifier, a cell identifier and an operator identifier. In an exemplary embodiment, the occupation signal transmitted by the first group of terminals and/or the second group of terminals may be in at least one of the following forms: a Sounding Reference Signal (SRS), a preamble, a Primary Synchronization Sequence/Secondary Synchronization Sequence (PSS/SSS), and a predetermined identifier.

In an exemplary embodiment, before the first group of terminals and/or the second group of terminals transmit the occupation signal on the entire unlicensed carrier bandwidth resources, the method may further include at least one of the following acts. A first terminal in the first group of terminals may determine that the first terminal and a second terminal which occupies the entire unlicensed carrier bandwidth resources in advance pertain to terminals in a same cell or different cells subordinate to a same operator. A third terminal in the second group of terminals may determine that the third terminal and a fourth terminal which occupies the entire unlicensed carrier bandwidth resources in advance pertain to terminals in a same cell or different cells subordinate to a same operator.

In an exemplary embodiment, when the first terminal determines that the first terminal and the second terminal pertain to terminals in the same cell or different cells subordinate to the same operator, the first terminal may determine whether a distance between the first terminal and the second terminal is greater than a first predetermined threshold and/or may determine whether a signal intensity, received by the first terminal, from the second terminal is smaller than a second predetermined threshold. If a determination result is positive, the first terminal may transmit the occupation signal, and otherwise, the first terminal may not transmit the occupation signal. Alternatively or additionally, when the third terminal determines that the third terminal and the fourth terminal pertain to terminals in the same cell or different cells subordinate to the same operator, the third terminal may determine whether a distance between the third terminal and the fourth terminal is greater than a first predetermined threshold and/or may determine whether a signal intensity, received by the third terminal, from the fourth terminal is smaller than a second predetermined threshold. If a determination result is positive, the third terminal may transmit the occupation signal, and otherwise, the third terminal may not transmit the occupation signal.

In an exemplary embodiment, a proportion of the occupation signal to a transmission bandwidth may be enabled to be greater than a predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources.

In an exemplary embodiment, at least one of a CCA pattern, an eCCA pattern and a data transmission pattern may be indicated by pre-scheduling information.

In an exemplary embodiment, at least one of the CCA pattern, the eCCA pattern and the data transmission pattern is of a Physical Resource Block (PRB) level or a Resource Element (RE) level.

In an exemplary embodiment, a pattern of the occupation signal may be indicated by pre-scheduling information.

In an exemplary embodiment, the pattern of the occupation signal may be of a PRB level or an RE level.

According to another embodiment of the present disclosure, an occupation signal transmission method is provided. The occupation signal transmission method may include the following acts. A first group of terminals and/or a second group of terminals may transmit an occupation signal by using at least one of the following manners. When detecting, on respective CCA and/or eCCA resources, that a channel is clear, the first group of terminals and/or the second group of terminals may transmit the occupation signal on the respective CCA and/or eCCA resources respectively. When detecting, on respective CCA and/or eCCA resources, that a channel is clear, the first group of terminals and/or the second group of terminals may transmit the occupation signal on an entire unlicensed carrier bandwidth respectively. When performing CCA and/or eCCA detection on entire unlicensed carrier bandwidth resources respectively and detecting that a channel is clear, the first group of terminals and/or the second group of terminals may respectively transmit the occupation signal on the entire unlicensed carrier bandwidth resources. When performing CCA and/or eCCA detection on entire unlicensed carrier bandwidth resources respectively and detecting that a channel is clear, the first group of terminals and/or the second group of terminals may transmit the occupation signal on respective CCA and/or eCCA resources respectively. In this embodiment, each group of the first group of terminals and/or the second group of terminals may include two or more terminals.

In an exemplary embodiment, the occupation signal transmitted by the first group of terminals and/or the second group of terminals may carry at least one of a group identifier, a cell identifier and an operator identifier. In an exemplary embodiment, the occupation signal transmitted by the first group of terminals and/or the second group of terminals may be in at least one of the following forms: an SRS, a preamble, a PSS/SSS, and a predetermined identifier.

In an exemplary embodiment, before the first group of terminals and/or the second group of terminals transmit an occupation signal, the method may further include at least one of the following acts. The first group of terminals and/or the second group of terminals may respectively perform CCA and/or eCCA detection on CCA and/or eCCA resources pre-configured for the first group of terminals and/or the second group of terminals. The first group of terminals and/or the second group of terminals may respectively perform CCA and/or eCCA detection on entire unlicensed carrier bandwidth resources.

In an exemplary embodiment, terminals in the first group of terminals may have at least one of the following characteristics: terminals in a same cell; terminals in different cells subordinate to a same operator; and terminals in different cells subordinate to different operators. In an exemplary embodiment, terminals in the second group of terminals may have at least one of the following characteristics: terminals in a same cell; terminals in different cells subordinate to a same operator; and terminals in different cells subordinate to different operators.

In an exemplary embodiment, the CCA and/or eCCA resources pre-configured for the first group of terminals and/or the second group of terminals may be configured by using at least one of the following manners. The CCA and/or eCCA resources may be configured by a base station. The CCA and/or eCCA resources may be configured via a negotiation between the first group of terminals and the second group of terminals.

In an exemplary embodiment, after the first group of terminals and/or the second group of terminals transmit the occupation signal, the method may further include at least one of the following acts. Data may be transmitted based on configured CCA and/or eCCA resources. Data may be transmitted based on pre-scheduling information.

In an exemplary embodiment, the act that the first group of terminals and/or the second group of terminals transmit the occupation signal on entire unlicensed carrier bandwidth resources may include one of the following acts. After the first group of terminals and/or the second group of terminals detect that a channel is clear, the first group of terminals and/or the second group of terminals may transmit an occupation signal on the entire unlicensed carrier bandwidth resources. After detecting that a channel is clear, the first group of terminals may transmit an occupation signal on the entire unlicensed carrier bandwidth resources, and when detecting that the channel is not clear, the second group of terminals may receive and parse the occupation signal transmitted by the first group of terminals.

In an exemplary embodiment, before the first group of terminals and/or the second group of terminals transmit the occupation signal on entire unlicensed carrier bandwidth resources, the method may further include at least one of the following acts. A first terminal in the first group of terminals may determine that the first terminal and a second terminal which occupies the entire unlicensed carrier bandwidth resources in advance pertain to terminals in a same cell or different cells subordinate to a same operator. A third terminal in the second group of terminals may determine that the third terminal and a fourth terminal which occupies the entire unlicensed carrier bandwidth resources in advance pertain to terminals in a same cell or different cells subordinate to a same operator.

In an exemplary embodiment, when the first terminal determines that the first terminal and the second terminal pertain to terminals in the same cell or different cells subordinate to the same operator, the first terminal may determine whether a distance between the first terminal and the second terminal is greater than a first predetermined threshold and/or may determine whether a signal intensity, received by the first terminal, from the second terminal is smaller than a second predetermined threshold. If a determination result is positive, the first terminal may transmit the occupation signal, and otherwise, the first terminal may not transmit the occupation signal. Alternatively or additionally, when the third terminal determines that the third terminal and the fourth terminal pertain to terminals in the same cell or different cells subordinate to the same operator, the third terminal may determine whether a distance between the third terminal and the fourth terminal is greater than a first predetermined threshold and/or may determine whether a signal intensity, received by the third terminal, from the fourth terminal is smaller than a second predetermined threshold. If a determination result is positive, the third terminal may transmit the occupation signal, and otherwise, the third terminal may not transmit the occupation signal.

In an exemplary embodiment, a proportion of the occupation signal to a transmission bandwidth may be enabled to be greater than a predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources.

In an exemplary embodiment, at least one of a CCA pattern, an eCCA pattern and a pattern of the occupation signal may be indicated by pre-scheduling information.

In an exemplary embodiment, at least one of the CCA pattern, the eCCA pattern and the pattern of the occupation signal may be of a PRB level or an RE level.

In an exemplary embodiment, a data transmission pattern may be indicated by pre-scheduling information.

In an exemplary embodiment, the data transmission pattern may be of a PRB level or an RE level.

According to another embodiment of the present disclosure, a data transmission method is provided. The data transmission method may include the following acts. A first group of terminals and/or a second group of terminals may transmit data by using at least one of the following manners: the first group of terminals and/or the second group of terminals may transmit data in frequency domain resources identical to CCA and/or eCCA resources pre-configured for the first group of terminals and/or the second group of terminals; and the first group of terminals and/or the second group of terminals may transmit data on entire unlicensed carrier bandwidth resources based on pre-scheduling information. In this embodiment, each group of the first group of terminals and/or the second group of terminals may include two or more terminals.

In an exemplary embodiment, before the first group of terminals and/or the second group of terminals transmit data, the method may further include the following acts. The first group of terminals and/or the second group of terminals may perform CCA and/or eCCA detection. After detecting that a channel is clear, the first group of terminals and/or the second group of terminals may transmit an occupation signal.

In an exemplary embodiment, the act that the first group of terminals and/or the second group of terminals perform CCA and/or eCCA detection may include one of the following acts. The first group of terminals and/or the second group of terminals may respectively perform CCA and/or eCCA detection on the CCA and/or eCCA resources pre-configured for the first group of terminals and/or the second group of terminals. The first group of terminals and/or the second group of terminals may perform CCA and/or eCCA detection on the entire unlicensed carrier bandwidth resources.

In an exemplary embodiment, terminals in the first group of terminals may have at least one of the following characteristics: terminals in a same cell; terminals in different cells subordinate to a same operator; and terminals in different cells subordinate to different operators. In an exemplary embodiment, terminals in the second group of terminals may have at least one of the following characteristics: terminals in a same cell; terminals in different cells subordinate to a same operator; and terminals in different cells subordinate to different operators.

In an exemplary embodiment, the CCA and/or eCCA resources pre-configured for the first group of terminals and/or the second group of terminals may be configured by using at least one of the following manners. The CCA and/or eCCA resources may be configured by a base station. The CCA and/or eCCA resources may be configured via a negotiation between the first group of terminals and the second group of terminals.

In an exemplary embodiment, the act that the first group of terminals and/or the second group of terminals transmit the occupation signal may include one of the following acts. The first group of terminals and/or the second group of terminals may transmit an occupation signal on respective CCA and/or eCCA resources. The first group of terminals and/or the second group of terminals may transmit an occupation signal on the entire unlicensed carrier bandwidth resources.

In an exemplary embodiment, the occupation signal transmitted by the first group of terminals and/or the second group of terminals may carry at least one of a group identifier, a cell identifier and an operator identifier. In an exemplary embodiment, the occupation signal transmitted by the first group of terminals and/or the second group of terminals may be in at least one of the following forms: an SRS, a preamble, a PSS/SSS, and a predetermined identifier.

In an exemplary embodiment, before the first group of terminals and/or the second group of terminals transmit the occupation signal on the entire unlicensed carrier bandwidth resources, the method may further include at least one of the following acts. A first terminal in the first group of terminals may determine that the first terminal and a second terminal which occupies the entire unlicensed carrier bandwidth resources in advance pertain to terminals in a same cell or different cells subordinate to a same operator. A third terminal in the second group of terminals may determine that the third terminal and a fourth terminal which occupies the entire unlicensed carrier bandwidth resources in advance pertain to terminals in a same cell or different cells subordinate to a same operator.

In an exemplary embodiment, when the first terminal determines that the first terminal and the second terminal pertain to terminals in the same cell or different cells subordinate to the same operator, the first terminal may determine whether a distance between the first terminal and the second terminal is greater than a first predetermined threshold and/or may determine whether a signal intensity, received by the first terminal, from the second terminal is smaller than a second predetermined threshold. If a determination result is positive, the first terminal may transmit the occupation signal, and otherwise, the first terminal may not transmit the occupation signal. Alternatively or additionally, when the third terminal determines that the third terminal and the fourth terminal pertain to terminals in the same cell or different cells subordinate to the same operator, the third terminal may determine whether a distance between the third terminal and the fourth terminal is greater than a first predetermined threshold and/or may determine whether a signal intensity, received by the third terminal, from the fourth terminal is smaller than a second predetermined threshold. If a determination result is positive, the third terminal may transmit the occupation signal, and otherwise, the third terminal may not transmit the occupation signal.

In an exemplary embodiment, a proportion of the occupation signal to a transmission bandwidth may be enabled to be greater than a predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources.

In an exemplary embodiment, at least one of a CCA pattern, an eCCA pattern and a data transmission pattern may be indicated by pre-scheduling information.

In an exemplary embodiment, at least one of the CCA pattern, the eCCA pattern and the data transmission pattern may be of a PRB level or an RE level.

In an exemplary embodiment, a pattern of the occupation signal may be indicated by pre-scheduling information.

In an exemplary embodiment, the pattern of the occupation signal may be of a PRB level or an RE level.

According to another embodiment of the present disclosure, a data transmission method is provided. The data transmission method may include the following acts. A first group of base stations and/or a second group of base stations may perform CCA and/or eCCA detection on unlicensed carrier bandwidth resources by using at least one of the following manners: the first group of base stations and/or the second group of base stations may respectively perform CCA and/or eCCA detection on CCA and/or eCCA resources respectively negotiated for the first group of base stations and/or the second group of base stations; or, the first group of base stations and/or the second group of base stations may respectively perform CCA and/or eCCA detection on entire unlicensed carrier bandwidth resources. In this embodiment, each group of the first group of base stations and/or the second group of base stations may include two or more base stations. The first group of base stations and/or the second group of base stations may determine subsequent data transmission based on a detection result.

In an exemplary embodiment, base stations in the first group of base stations may have at least one of the following characteristics: base stations subordinate to a same operator; and base stations subordinate to different operators. Base stations in the second group of base stations may have at least one of the following characteristics: base stations subordinate to a same operator; and base stations subordinate to different operators.

In an exemplary embodiment, after the first group of base stations and/or the second group of base stations perform CCA and/or eCCA detection on CCA and/or eCCA resources respectively negotiated for the first group of base stations and/or the second group of base stations, the method may further include the following acts. The first group of base stations and/or the second group of base stations may determine that a channel is clear. The first group of base stations and/or the second group of base stations may respectively transmit an occupation signal on the CCA and/or eCCA resources respectively negotiated for the first group of base stations and/or the second group of base stations; or, the first group of base stations and/or the second group of base stations may transmit an occupation signal on the entire unlicensed carrier bandwidth resources. The first group of base stations and/or the second group of base stations may determine subsequent data transmission based on the transmitted occupation signal.

In an exemplary embodiment, after the first group of base stations and/or the second group of base stations respectively perform CCA and/or eCCA detection on entire unlicensed carrier bandwidth resources, the method may further include the following acts. The first group of base stations and/or the second group of base stations may determine that a channel is clear. After detecting that the channel is clear, the first group of base stations and/or the second group of base stations may respectively transmit an occupation signal on the entire unlicensed carrier bandwidth resources; or, after detecting that the channel is clear, the first group of base stations may transmit an occupation signal on the entire unlicensed carrier bandwidth resources, and when detecting that the channel is not clear, the second group of base stations may receive and parse the occupation signal transmitted by the first group of base stations.

In an exemplary embodiment, the occupation signal transmitted by the first group of base stations and/or the second group of base stations may carry at least one of a group identifier, a cell identifier and an operator identifier. In an exemplary embodiment, the occupation signal transmitted by the first group of base stations and/or the second group of base stations may be in at least one of the following forms: an SRS, a preamble, a PSS/SSS, and a predetermined identifier.

In an exemplary embodiment, before the first group of base stations and/or the second group of base stations transmit the occupation signal on the entire unlicensed carrier bandwidth resources, the method may further include at least one of the following acts. A first base station in the first group of base stations may determine that the first base station and a second base station which occupies the entire unlicensed carrier bandwidth resources in advance pertain to base stations subordinate to a same operator. A third base station in the second group of base stations may determine that the third base station and a fourth base station which occupies the entire unlicensed carrier bandwidth resources in advance pertain to base stations subordinate to a same operator.

In an exemplary embodiment, when the first base station determines that the first base station and the second base station pertain to base stations subordinate to the same operator, the first base station may determine whether a distance between the first base station and the second base station is greater than a first predetermined threshold and/or may determine whether a signal intensity, received by the first base station, from the second base station is smaller than a second predetermined threshold. If a determination result is positive, the first base station may transmit the occupation signal, and otherwise, the first base station may not transmit the occupation signal. Alternatively or additionally, when the third base station determines that the third base station and the fourth base station pertain to base stations subordinate to the same operator, the third base station may determine whether a distance between the third base station and the fourth base station is greater than a first predetermined threshold and/or may determine whether a signal intensity, received by the third base station, from the fourth base station is smaller than a second predetermined threshold. If a determination result is positive, the third base station may transmit the occupation signal, and otherwise, the third base station may not transmit the occupation signal.

In an exemplary embodiment, a proportion of the occupation signal to a transmission bandwidth may be enabled to be greater than a predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources.

In an exemplary embodiment, at least one of a CCA pattern, an eCCA pattern and a data transmission pattern may be indicated by pre-scheduling information.

In an exemplary embodiment, at least one of the CCA pattern, the eCCA pattern and the data transmission pattern may be of a PRB level or an RE level.

In an exemplary embodiment, a pattern of the occupation signal may be indicated by pre-scheduling information.

In an exemplary embodiment, the pattern of the occupation signal may be of a PRB level or an RE level.

According to another embodiment of the present disclosure, an occupation signal transmission method is provided. The occupation signal transmission method may include the following acts. A first group of base stations and/or a second group of base stations may transmit an occupation signal by using at least one of the following manners. When detecting, on respective CCA and/or eCCA resources, that a channel is clear, the first group of base stations and/or the second group of base stations may transmit an occupation signal on the respective CCA and/or eCCA resources respectively. When detecting, on respective CCA and/or eCCA resources, that a channel is clear, the first group of base stations and/or the second group of base stations may transmit an occupation signal on an entire unlicensed carrier bandwidth respectively. When performing CCA and/or eCCA detection on entire unlicensed carrier bandwidth resources respectively and detecting that a channel is clear, the first group of base stations and/or the second group of base stations may respectively transmit an occupation signal on the entire unlicensed carrier bandwidth resources. When performing CCA and/or eCCA detection on entire unlicensed carrier bandwidth resources respectively and detecting that a channel is clear, the first group of base stations and/or the second group of base stations may transmit an occupation signal in respectively-negotiated resources. In the embodiment, each group of the first group of base stations and/or the second group of base stations may include two or more base stations.

In an exemplary embodiment, the occupation signal transmitted by the first group of base stations and/or the second group of base stations may carry at least one of a group identifier, a cell identifier and an operator identifier. In an exemplary embodiment, the occupation signal transmitted by the first group of base stations and/or the second group of base stations may be in at least one of the following forms: an SRS, a preamble, a PSS/SSS, and a predetermined identifier.

In an exemplary embodiment, before the first group of base stations and/or the second group of base stations transmit the occupation signal, the method may further include at least one of the following acts. The first group of base stations and/or the second group of base stations may respectively perform CCA and/or eCCA detection on CCA and/or eCCA resources respectively negotiated for the first group of base stations and/or the second group of base stations. The first group of base stations and/or the second group of base stations may respectively perform CCA and/or eCCA detection on entire unlicensed carrier bandwidth resources.

In an exemplary embodiment, base stations in the first group of base stations may have at least one of the following characteristics: base stations subordinate to a same operator; and base stations subordinate to different operators. Base stations in the second group of base stations may have at least one of the following characteristics: base stations subordinate to a same operator; and base stations subordinate to different operators.

In an exemplary embodiment, after the first group of base stations and/or the second group of base stations transmit the occupation signal, the method may further include the following act. Data may be transmitted based on configured CCA and/or eCCA resources.

In an exemplary embodiment, the act that the first group of base stations and/or the second group of base stations transmit the occupation signal on entire unlicensed carrier bandwidth resources may include one of the following acts. After the first group of base stations and/or the second group of base stations detect that a channel is clear, the first group of base stations and/or the second group of base stations may transmit the occupation signal on the entire unlicensed carrier bandwidth resources. After detecting that a channel is clear, the first group of base stations may transmit an occupation signal on the entire unlicensed carrier bandwidth resources, and when detecting that the channel is not clear, the second group of base stations may receive and parse the occupation signal transmitted by the first group of base stations.

In an exemplary embodiment, before the first group of base stations and/or the second group of base stations transmit the occupation signal on entire unlicensed carrier bandwidth resources, the method may further include at least one of the following acts. A first base station in the first group of base stations may determine that the first base station and a second base station which occupies the entire unlicensed carrier bandwidth resources in advance pertain to base stations subordinate to a same operator. A third base station in the second group of base stations may determine that the third base station and a fourth base station which occupies the entire unlicensed carrier bandwidth resources in advance pertain to base stations subordinate to a same operator.

In an exemplary embodiment, when the first base station determines that the first base station and the second base station pertain to base stations subordinate to the same operator, the first base station may determine whether a distance between the first base station and the second base station is greater than a first predetermined threshold and/or may determine whether a signal intensity, received by the first base station, from the second base station is smaller than a second predetermined threshold. If a determination result is positive, the first base station may transmit the occupation signal, and otherwise, the first base station may not transmit the occupation signal. Alternatively or additionally, when the third base station determines that the third base station and the fourth base station pertain to base stations subordinate to the same operator, the third base station may determine whether a distance between the third base station and the fourth base station is greater than a first predetermined threshold and/or may determine whether a signal intensity, received by the third base station, from the fourth base station is smaller than a second predetermined threshold. If a determination result is positive, the third base station may transmit the occupation signal, and otherwise, the third base station may not transmit the occupation signal.

In an exemplary embodiment, a proportion of the occupation signal to a transmission bandwidth may be enabled to be greater than a predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources.

In an exemplary embodiment, at least one of a CCA pattern, an eCCA pattern and a pattern of the occupation signal may be indicated by pre-scheduling information.

In an exemplary embodiment, at least one of the CCA pattern, the eCCA pattern and the pattern of the occupation signal may be of a PRB level or an RE level.

In an exemplary embodiment, a data transmission pattern may be indicated by pre-scheduling information.

In an exemplary embodiment, the data transmission pattern may be of a PRB level or an RE level.

According to another embodiment of the present disclosure, a data transmission method is provided. The data transmission method may include the following acts. A first group of base stations and/or a second group of base stations may transmit data by using at least one of the following manners: the first group of base stations and/or the second group of base stations may transmit data in frequency domain resources identical to CCA and/or eCCA resources negotiated in advance for the first group of base stations and/or the second group of base stations; and the first group of base stations and/or the second group of base stations may transmit data on entire unlicensed carrier bandwidth resources based on an advance resource negotiation result. In the embodiment, each group of the first group of base stations and/or the second group of base stations may include two or more base stations.

In an exemplary embodiment, base stations in the first group of base stations may have at least one of the following characteristics: base stations subordinate to a same operator; and base stations subordinate to different operators. Base stations in the second group of base stations may have at least one of the following characteristics: base stations subordinate to a same operator; and base stations subordinate to different operators.

In an exemplary embodiment, before the first group of base stations and/or the second group of base stations transmit data, the method may further include the following acts. The first group of base stations and/or the second group of base stations may perform CCA and/or eCCA detection. After detecting that a channel is clear, the first group of base stations and/or the second group of base stations may transmit an occupation signal.

In an exemplary embodiment, the act that the first group of base stations and/or the second group of base stations perform CCA and/or eCCA detection may include one of the following acts. The first group of base stations and/or the second group of base stations may respectively perform CCA and/or eCCA detection on the CCA and/or eCCA resources negotiated in advance for the first group of base stations and/or the second group of base stations. The first group of base stations and/or the second group of base stations may perform CCA and/or eCCA detection on the entire unlicensed carrier bandwidth resources.

In an exemplary embodiment, the act that the first group of base stations and/or the second group of base stations transmit the occupation signal may include one of the following acts. The first group of base stations and/or the second group of base stations may transmit an occupation signal on the CCA and/or eCCA resources negotiated in advance. The first group of base stations and/or the second group of base stations may transmit an occupation signal on the entire unlicensed carrier bandwidth resources.

In an exemplary embodiment, the occupation signal transmitted by the first group of base stations and/or the second group of base stations may carry at least one of a group identifier, a cell identifier and an operator identifier. In an exemplary embodiment, the occupation signal transmitted by the first group of base stations and/or the second group of base stations may be in at least one of the following forms: an SRS, a preamble, a PSS/SSS, and a predetermined identifier.

In an exemplary embodiment, before the first group of base stations and/or the second group of base stations transmit the occupation signal on the entire unlicensed carrier bandwidth resources, the method may further include at least one of the following acts. A first base station in the first group of base stations may determine that the first base station and a second base station which occupies the entire unlicensed carrier bandwidth resources in advance pertain to base stations subordinate to a same operator. A third base station in the second group of base stations may determine that the third base station and a fourth base station which occupies the entire unlicensed carrier bandwidth resources in advance pertain to base stations subordinate to a same operator.

In an exemplary embodiment, when the first base station determines that the first base station and the second base station pertain to base stations subordinate to the same operator, the first base station may determine whether a distance between the first base station and the second base station is greater than a first predetermined threshold and/or may determine whether a signal intensity, received by the first base station, from the second base station is smaller than a second predetermined threshold. If a determination result is positive, the first base station may transmit the occupation signal, and otherwise, the first base station may not transmit the occupation signal. Alternatively or additionally, when the third base station determines that the third base station and the fourth base station pertain to base stations subordinate to the same operator, the third base station may determine whether a distance between the third base station and the fourth base station is greater than a first predetermined threshold and/or may determine whether a signal intensity, received by the third base station, from the fourth base station is smaller than a second predetermined threshold. If a determination result is positive, the third base station may transmit the occupation signal, and otherwise, the third base station may not transmit the occupation signal.

In an exemplary embodiment, a proportion of the occupation signal to a transmission bandwidth may be enabled to be greater than a predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources.

In an exemplary embodiment, at least one of a CCA pattern, an eCCA pattern and a data transmission pattern may be indicated by pre-scheduling information.

In an exemplary embodiment, at least one of the CCA pattern, the eCCA pattern and the data transmission pattern may be of a PRB level or an RE level.

In an exemplary embodiment, a pattern of the occupation signal may be indicated by pre-scheduling information.

In an exemplary embodiment, the pattern of the occupation signal may be of a PRB level or an RE level.

According to another embodiment of the present disclosure, a data transmission device is provided. The device may be applied to a first group of terminals and/or a second group of terminals, and may include: a first detection module and a first determination module. The first detection module may be configured to perform CCA and/or eCCA detection on unlicensed carrier bandwidth resources by using at least one of the following manners: the first group of terminals and/or the second group of terminals may respectively perform CCA and/or eCCA detection on CCA and/or eCCA resources pre-configured for the first group of terminals and/or the second group of terminals; and the first group of terminals and/or the second group of terminals may respectively perform CCA and/or eCCA detection on entire unlicensed carrier bandwidth resources. In this embodiment, each group of the first group of terminals and/or the second group of terminals may include two or more terminals. The first determination module may be configured to determine subsequent data transmission based on a detection result.

According to another embodiment of the present disclosure, an occupation signal transmission device is provided. The device may be applied to a first group of terminals and/or a second group of terminals, and may include: a first transmission module. The first transmission module may be configured to transmit an occupation signal by using at least one of the following manners. When detecting, on respective CCA and/or eCCA resources, that a channel is clear, the first group of terminals and/or the second group of terminals may transmit an occupation signal on the respective CCA and/or eCCA resources respectively. When detecting, on respective CCA and/or eCCA resources, that a channel is clear, the first group of terminals and/or the second group of terminals may transmit an occupation signal on an entire unlicensed carrier bandwidth respectively. When performing CCA and/or eCCA detection on entire unlicensed carrier bandwidth resources respectively and detecting that a channel is clear, the first group of terminals and/or the second group of terminals may respectively transmit an occupation signal on the entire unlicensed carrier bandwidth resources. When performing CCA and/or eCCA detection on entire unlicensed carrier bandwidth resources respectively and detecting that a channel is clear, the first group of terminals and/or the second group of terminals may transmit an occupation signal on respective CCA and/or eCCA resources respectively. In this embodiment, each group of the first group of terminals and/or the second group of terminals may include two or more terminals.

According to another embodiment of the present disclosure, a data transmission device is provided. The device may be applied to a first group of terminals and/or a second group of terminals, and may include: a second transmission module. The second transmission module may be configured to transmit data by using at least one of the following manners: the first group of terminals and/or the second group of terminals may transmit data in frequency domain resources identical to CCA and/or eCCA resources pre-configured for the first group of terminals and/or the second group of terminals; and the first group of terminals and/or the second group of terminals may transmit data on entire unlicensed carrier bandwidth resources based on pre-scheduling information. In this embodiment, each group of the first group of terminals and/or the second group of terminals may include two or more terminals.

According to another embodiment of the present disclosure, a data transmission device is provided. The device may be applied to a first group of base stations and/or a second group of base stations, and may include: a second detection module and a second determination module. The second detection module may be configured to perform CCA and/or eCCA detection on unlicensed carrier bandwidth resources by using at least one of the following manners: the first group of base stations and/or the second group of base stations may respectively perform CCA and/or eCCA detection on CCA and/or eCCA resources respectively negotiated for the first group of base stations and/or the second group of base stations; or, the first group of base stations and/or the second group of base stations may respectively perform CCA and/or eCCA detection on entire unlicensed carrier bandwidth resources. In this embodiment, each group of the first group of base stations and/or the second group of base stations may include two or more base stations. The second determination module may be configured to determine subsequent data transmission based on a detection result.

According to another embodiment of the present disclosure, an occupation signal transmission device is provided. The device may be applied to a first group of base stations and/or a second group of base stations, and may include: a third transmission module. The third transmission module may be configured to transmit an occupation signal by using at least one of the following manners. When detecting, on respective CCA and/or eCCA resources, that a channel is clear, the first group of base stations and/or the second group of base stations may transmit an occupation signal on the respective CCA and/or eCCA resources respectively. When detecting, on respective CCA and/or eCCA resources, that a channel is clear, the first group of base stations and/or the second group of base stations may transmit an occupation signal on an entire unlicensed carrier bandwidth respectively. When performing CCA and/or eCCA detection on entire unlicensed carrier bandwidth resources respectively and detecting that a channel is clear, the first group of base stations and/or the second group of base stations may respectively transmit an occupation signal on the entire unlicensed carrier bandwidth resources. When performing CCA and/or eCCA detection on entire unlicensed carrier bandwidth resources respectively and detecting that a channel is clear, the first group of base stations and/or the second group of base stations may transmit an occupation signal in respectively-negotiated resources. In the embodiment, each group of the first group of base stations and/or the second group of base stations may include two or more base stations.

According to another embodiment of the present disclosure, a data transmission device is provided. The device may be applied to a first group of base stations and/or a second group of base stations, and may include: a fourth transmission module. The fourth transmission module may be configured to transmit data by using at least one of the following manners: the first group of base stations and/or the second group of base stations may transmit data in frequency domain resources identical to CCA and/or eCCA resources negotiated in advance for the first group of base stations and/or the second group of base stations; and the first group of base stations and/or the second group of base stations may transmit data on entire unlicensed carrier bandwidth resources based on an advance resource negotiation result. In the embodiment, each group of the first group of base stations and/or the second group of base stations may include two or more base stations.

By means of some embodiments of the present disclosure, a first group of terminals and/or a second group of terminals may perform CCA and/or eCCA detection on unlicensed carrier bandwidth resources by using at least one of the following manners: the first group of terminals and/or the second group of terminals may respectively perform CCA and/or eCCA detection on CCA and/or eCCA resources pre-configured for the first group of terminals and/or the second group of terminals; the first group of terminals and/or the second group of terminals may respectively perform CCA and/or eCCA detection on the entire unlicensed carrier bandwidth resources. In this embodiment, each group of the first group of terminals and/or the second group of terminals may include two or more terminals. The first group of terminals and/or the second group of terminals may determine subsequent data transmission based on a detection result. A problem of interference during data transmission through an unlicensed carrier may be solved, thereby achieving an effect of interference reduction.

### BRIEF DESCRIPTION OF THE DRAWINGS

FIG. 1 is a flowchart of a first implementation of a data transmission method according to an embodiment of the present disclosure;

FIG. 2 is a flowchart of a first implementation of an occupation signal transmission method according to an embodiment of the present disclosure;

FIG. 3 is a flowchart of a second implementation of a data transmission method according to an embodiment of the present disclosure;

FIG. 4 is a flowchart of a third implementation of a data transmission method according to an embodiment of the present disclosure;

FIG. 5 is a flowchart of a second implementation of an occupation signal transmission method according to an embodiment of the present disclosure;

FIG. 6 is a flowchart of a fourth implementation of a data transmission method according to an embodiment of the present disclosure;

FIG. 7 is a block diagram of a first implementation of a data transmission device according to an embodiment of the present disclosure;

FIG. 8 illustrates a first implementation of an occupation signal transmission device according to an embodiment of the present disclosure;

FIG. 9 is a block diagram of a second implementation of a data transmission device according to an embodiment of the present disclosure;

FIG. 10 is a block diagram of a third implementation of a data transmission device according to an embodiment of the present disclosure;

FIG. 11 illustrates a second implementation of an occupation signal transmission device according to an embodiment of the present disclosure;

FIG. 12 is a block diagram of a fourth implementation of a data transmission device according to an embodiment of the present disclosure;

FIG. 13 is a diagram of solving a hidden node in an inter-system coexistence scenario according to a first embodiment of the present disclosure;

FIG. 14 is a diagram of solving a hidden node in an inter-system coexistence scenario according to a second embodiment of the present disclosure;

FIG. 15 is an overall flowchart showing execution of CCA and/or eCCA and identification of an occupation signal through a UE according to a third embodiment of the present disclosure;

FIG. 16 is a diagram illustrating a process for a UE which does not succeed in contention according to a fourth embodiment of the present disclosure;

FIG. 17 is a diagram of transmission of an occupation signal for measurement function by a UE according to a fifth embodiment of the present disclosure;

FIG. 18 is a diagram of an occupation signal which meets a control requirement according to various rules according to a sixth embodiment of the present disclosure; and

FIG. 19 is a diagram of CCA and/or eCCA resources or data resources according to an embodiment of the present disclosure.

### DETAILED DESCRIPTION OF THE EMBODIMENTS

It should be noted that the specification and claims of the present disclosure and terms ‘first’, ‘second’ and the like in the drawings are used to distinguish similar objects, and are not used to describe a specific sequence or a precedence order.

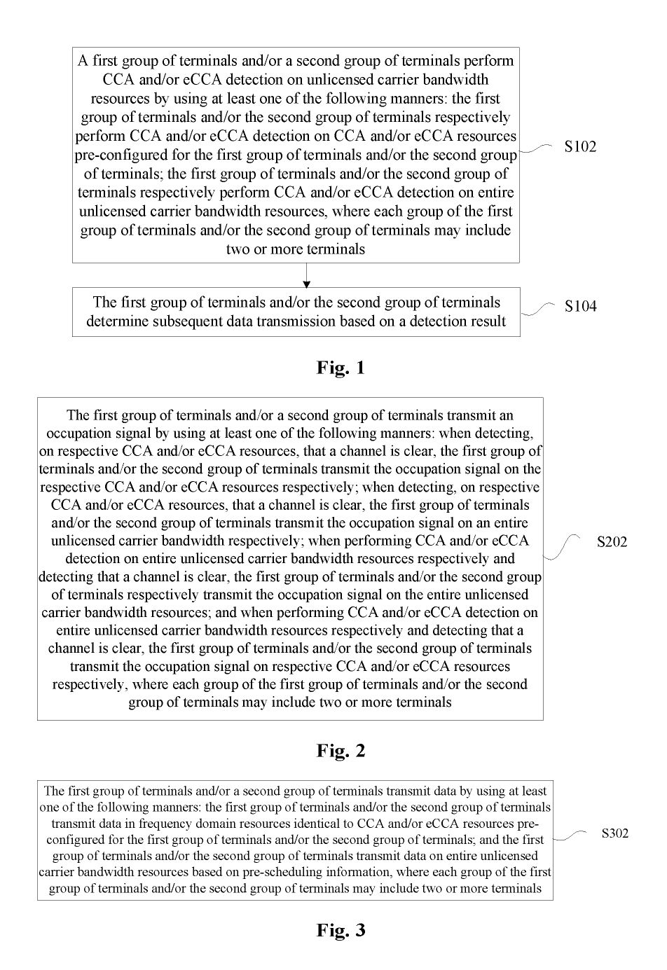

In the present embodiment, an unlicensed carrier occupation method is provided. FIG. 1 is a flowchart of a first implementation of a data transmission method according to an embodiment of the present disclosure. As shown in FIG. 1, the flow may include the acts S102 and S104 as follows.

At act S102, a first group of terminals and/or a second group of terminals may perform CCA and/or eCCA detection on unlicensed carrier bandwidth resources by using at least one of the following manners. The first group of terminals and/or the second group of terminals may respectively perform CCA and/or eCCA detection on CCA and/or eCCA resources pre-configured for the first group of terminals and/or the second group of terminals. The first group of terminals and/or the second group of terminals may respectively perform CCA and/or eCCA detection on entire unlicensed carrier bandwidth resources. In this embodiment, each group of the first group of terminals and/or the second group of terminals may include two or more terminals.

At act S104, the first group of terminals and/or the second group of terminals may determine subsequent data transmission based on a detection result.

By means of the above acts, a group of terminals perform CCA and/or eCCA detection on unlicensed carrier bandwidth resources, and subsequently, a group of terminals transmit data over a clear unlicensed carrier. Compared with a solution of adopting a single terminal to perform CCA and/or eCCA detection for data transmission, the solution may effectively improve the reuse rate of resources, and may achieve an effect that multiple terminals may transmit data at the same time, thereby improving the efficiency of data exchange between a terminal and other nodes. Therefore, a problem of low reuse rate of resources may be solved, thereby achieving the effect of improving the reuse rate of resources.

From the above acts, it may be concluded that each group of terminals may include multiple terminals. The multiple terminals in the same group may have a certain characteristic. In an exemplary embodiment, terminals in the first group of terminals may have at least one of the following characteristics: terminals in a same cell; terminals in different cells subordinate to a same operator; and UEs in different cells subordinate to different operators. In an exemplary embodiment, terminals in the second group of terminals may have at least one of the following characteristics: terminals in a same cell; terminals in different cells subordinate to a same operator; and UEs in different cells subordinate to different operators.

There may be multiple configuration manners for the CCA and/or eCCA resources pre-configured. In an exemplary embodiment, the CCA and/or eCCA resources pre-configured for the first group of terminals and/or the second group of terminals may be configured by using at least one of the following manners. The CCA and/or eCCA resources may be configured by a base station. The CCA and/or eCCA resources may be configured via a negotiation between the first group of terminals and the second group of terminals.

Herein, after the first group of terminals and/or the second group of terminals perform CCA and/or eCCA detection on the pre-configured CCA and/or eCCA resources, if it is discovered that a channel is clear, the first group of terminals and/or the second group of terminals may transmit an occupation signal for occupying the clear channel. The operation may include the following acts. The first group of terminals and/or the second group of terminals may determine that the channel is clear. The first group of terminals and/or the second group of terminals may respectively transmit an occupation signal on unlicensed carrier bandwidth resources subjected to CCA and/or eCCA detection; or, the first group of terminals and/or the second group of terminals may respectively transmit an occupation signal on the entire unlicensed carrier bandwidth resources. The first group of terminals and/or the second group of terminals may determine subsequent data transmission based on the transmitted occupation signal. Herein, after a certain terminal in one group obtains, through contention, some unlicensed carrier resources pre-configured or entire unlicensed carrier resources, other terminals in this group may transmit data by using the secured unlicensed carrier resources pre-configured or the entire unlicensed carrier resources. That is to say, a group of terminals may reuse the unlicensed carrier resources together.

In an exemplary embodiment, after the first group of terminals and/or the second group of terminals respectively perform CCA and/or eCCA detection on the entire unlicensed carrier bandwidth resources, the method may further include the following acts. The first group of terminals and/or the second group of terminals may detect that a channel is clear. After detecting that the channel is clear, the first group of terminals and/or the second group of terminals may respectively transmit an occupation signal on the entire unlicensed carrier bandwidth resources; or, after detecting that the channel is clear, the first group of terminals may transmit an occupation signal on the entire unlicensed carrier bandwidth resources, and when detecting that the channel is not clear, the second group of terminals may receive and parse the occupation signal transmitted by the first group of terminals.

In the exemplary embodiment, the occupation signal transmitted by the first group of terminals and/or the second group of terminals may carry at least one of a group identifier, a cell identifier and an operator identifier. In the exemplary embodiment, the occupation signal transmitted by the first group of terminals and/or the second group of terminals may be in at least one of the following forms: an SRS, a preamble, a PSS/SSS, and a predetermined identifier.

In an exemplary embodiment, before the first group of terminals and/or the second group of terminals transmit the occupation signal on the entire unlicensed carrier bandwidth resources, the method may further include at least one of the following acts. A first terminal in the first group of terminals may determine that the first terminal and a second terminal which occupies the entire unlicensed carrier bandwidth resources in advance pertain to terminals in a same cell or different cells subordinate to a same operator. A third terminal in the second group of terminals may determine that the third terminal and a fourth terminal which occupies the entire unlicensed carrier bandwidth resources in advance pertain to terminals in a same cell or different cells subordinate to a same operator. In the exemplary embodiment, terminals in different groups may pertain to the same cell or the same operator.

Herein, when the first terminal determines that the first terminal and the second terminal pertain to terminals in the same cell or different cells subordinate to the same operator, the first terminal may determine whether a distance between the first terminal and the second terminal is greater than a first predetermined threshold and/or may determine whether a signal intensity, received by the first terminal, from the second terminal is smaller than a second predetermined threshold. If a determination result is positive, the first terminal may transmit the occupation signal, and otherwise, the first terminal may not transmit the occupation signal. Alternatively or additionally, when the third terminal determines that the third terminal and the fourth terminal pertain to terminals in the same cell or different cells subordinate to the same operator, the third terminal may determine whether a distance between the third terminal and the fourth terminal is greater than a first predetermined threshold and/or may determine whether a signal intensity, received by the third terminal, from the fourth terminal is smaller than a second predetermined threshold. If a determination result is positive, the third terminal may transmit the occupation signal, and otherwise, the third terminal may not transmit the occupation signal.

It should be noted that the occupation signal may satisfy a certain rule. In an exemplary embodiment, a proportion of the occupation signal to a transmission bandwidth may be greater than a predetermined proportion. In an exemplary embodiment, the proportion of the occupation signal to the transmission bandwidth may be enabled to be greater than the predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources. The proportion may be flexibly set as, for example, 80%.

In an exemplary embodiment, at least one of a CCA pattern, an eCCA pattern, a pattern of the occupation signal and a data transmission pattern may be indicated by pre-scheduling information. That is, pre-scheduling information may carry at least one of a CCA pattern, an eCCA pattern, a pattern of the occupation signal and a data transmission pattern.

FIG. 2 is a flowchart of a first implementation of an occupation signal transmission method according to an embodiment of the present disclosure. As shown in FIG. 2, the flow may include the act S202 as follows.

At act S202, a first group of terminals and/or a second group of terminals may transmit an occupation signal by using at least one of the following manners. When detecting, on respective CCA and/or eCCA resources, that a channel is clear, the first group of terminals and/or the second group of terminals may transmit an occupation signal on the respective CCA and/or eCCA resources respectively. When detecting, on respective CCA and/or eCCA resources, that a channel is clear, the first group of terminals and/or the second group of terminals may transmit an occupation signal on an entire unlicensed carrier bandwidth respectively. When respectively performing CCA and/or eCCA detection on entire unlicensed carrier bandwidth resources and detecting that a channel is clear, the first group of terminals and/or the second group of terminals may respectively transmit an occupation signal on the entire unlicensed carrier bandwidth resources. When respectively performing CCA and/or eCCA detection on entire unlicensed carrier bandwidth resources and detecting that a channel is clear, the first group of terminals and/or the second group of terminals may transmit an occupation signal on respective CCA and/or eCCA resources respectively. In this embodiment, each group of the first group of terminals and/or the second group of terminals may include two or more terminals.

By means of the above acts, when detecting whether a channel is clear, a terminal in one group may detect whether entire unlicensed carrier resources are clear, and may alternatively detect whether respective CCA and/or eCCA resources are clear. Moreover, each checking manner may correspond to two occupation signal transmission manners: 1, transmitting an occupation signal over an entire unlicensed carrier bandwidth, and 2, transmitting an occupation signal on respective CCA and/or eCCA resources. Moreover, from the above act, it may be concluded that both detection and occupation signal transmission may be executed by a group of terminals, therefore, the reuse rate of resources may be effectively improved. In addition, multiple terminals may transmit data at the same time, so that the efficiency of data exchange between a terminal and other nodes may be improved. Therefore, a problem of low reuse rate of resources may be solved, thereby achieving the effect of improving the reuse rate of resources.

In an exemplary embodiment, the occupation signal transmitted by the first group of terminals and/or the second group of terminals may carry at least one of a group identifier, a cell identifier and an operator identifier. In an exemplary embodiment, the occupation signal transmitted by the first group of terminals and/or the second group of terminals may be in at least one of the following forms: an SRS, a preamble, a PSS/SSS, and a predetermined identifier.

Herein, before the first group of terminals and/or the second group of terminals transmit the occupation signal, CCA and/or eCCA detection may be performed first. The operation may include at least one of the following acts. The first group of terminals and/or the second group of terminals may respectively perform CCA and/or eCCA detection on CCA and/or eCCA resources pre-configured for the first group of terminals and/or the second group of terminals. The first group of terminals and/or the second group of terminals may respectively perform CCA and/or eCCA detection on entire unlicensed carrier bandwidth resources.

From the above acts, it may be concluded that each group of terminals may include multiple terminals. The multiple terminals in the same group may have a certain characteristic. In an exemplary embodiment, terminals in the first group of terminals may have at least one of the following characteristics: terminals in a same cell; terminals in different cells subordinate to a same operator; and UEs in different cells subordinate to different operators. In an exemplary embodiment, terminals in the second group of terminals may have at least one of the following characteristics: terminals in a same cell; terminals in different cells subordinate to a same operator; and UEs in different cells subordinate to different operators. Herein, after a certain terminal in one group obtains, through contention, some unlicensed carrier resources pre-configured or entire unlicensed carrier resources, other terminals in this group may transmit data by using the secured unlicensed carrier resources pre-configured or the entire unlicensed carrier resources. That is to say, a group of terminals may reuse the unlicensed carrier resources together.

There may be multiple configuration manners for the CCA and/or eCCA resources pre-configured. In an exemplary embodiment, the CCA and/or eCCA resources pre-configured for the first group of terminals and/or the second group of terminals may be configured by using at least one of the following manners. The CCA and/or eCCA resources may be configured by a base station. The CCA and/or eCCA resources may be configured via a negotiation between the first group of terminals and the second group of terminals.

In an exemplary embodiment, after the first group of terminals and/or the second group of terminals transmit the occupation signal, the method may further include at least one of the following acts. Data may be transmitted based on configured CCA and/or eCCA resources. Data may be transmitted based on pre-scheduling information.

The act that the first group of terminals and/or the second group of terminals transmit the occupation signal on entire unlicensed carrier bandwidth resources may include one of the following acts. After the first group of terminals and/or the second group of terminals detect that a channel is clear, the first group of terminals and/or the second group of terminals may transmit an occupation signal on the entire unlicensed carrier bandwidth resources. After detecting that a channel is clear, the first group of terminals may transmit an occupation signal on the entire unlicensed carrier bandwidth resources, and when detecting that the channel is not clear, the second group of terminals may receive and parse the occupation signal transmitted by the first group of terminals.

In an exemplary embodiment, before the first group of terminals and/or the second group of terminals transmit the occupation signal on entire unlicensed carrier bandwidth resources, the method may further include at least one of the following acts. A first terminal in the first group of terminals may determine that the first terminal and a second terminal which occupies the entire unlicensed carrier bandwidth resources in advance pertain to terminals in a same cell or different cells subordinate to a same operator. A third terminal in the second group of terminals may determine that the third terminal and a fourth terminal which occupies the entire unlicensed carrier bandwidth resources in advance pertain to terminals in a same cell or different cells subordinate to a same operator. In the exemplary embodiment, terminals in different groups may pertain to the same cell or the same operator.

Herein, when the first terminal determines that the first terminal and the second terminal pertain to terminals in the same cell or different cells subordinate to the same operator, the first terminal may determine whether a distance between the first terminal and the second terminal is greater than a first predetermined threshold and/or may determine whether a signal intensity, received by the first terminal, from the second terminal is smaller than a second predetermined threshold. If a determination result is positive, the first terminal may transmit the occupation signal, and otherwise, the first terminal may not transmit the occupation signal. Alternatively or additionally, when the third terminal determines that the third terminal and the fourth terminal pertain to terminals in the same cell or different cells subordinate to the same operator, the third terminal may determine whether a distance between the third terminal and the fourth terminal is greater than a first predetermined threshold and/or may determine whether a signal intensity, received by the third terminal, from the fourth terminal is smaller than a second predetermined threshold. If a determination result is positive, the third terminal may transmit the occupation signal, and otherwise, the third terminal may not transmit the occupation signal.

It should be noted that the occupation signal may satisfy a certain rule. In an exemplary embodiment, a proportion of the occupation signal to a transmission bandwidth may be greater than a predetermined proportion. In an exemplary embodiment, the proportion of the occupation signal to the transmission bandwidth may be enabled to be greater than the predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources. The proportion may be flexibly set as, for example, 80%.

In an exemplary embodiment, at least one of a CCA pattern, an eCCA pattern, a pattern of the occupation signal and a data transmission pattern may be indicated by pre-scheduling information. That is, pre-scheduling information may carry at least one of a CCA pattern, an eCCA pattern, a pattern of the occupation signal and a data transmission pattern.

FIG. 3 is a flowchart of a second implementation of a data transmission method according to an embodiment of the present disclosure. As shown in FIG. 3, the method may include the act S302 as follows.

At act S302, a first group of terminals and/or a second group of terminals may transmit data by using at least one of the following manners: the first group of terminals and/or the second group of terminals may transmit data in frequency domain resources identical to CCA and/or eCCA resources pre-configured for the first group of terminals and/or the second group of terminals; and the first group of terminals and/or the second group of terminals may transmit data on entire unlicensed carrier bandwidth resources based on pre-scheduling information. In this embodiment, each group of the first group of terminals and/or the second group of terminals may include two or more terminals.

Based on the above act, it may be concluded that during data transmission of each group of terminals, there may be two transmission manners, data may be transmitted in frequency domain resources identical to CCA and/or eCCA resources pre-configured for the group of terminals or may be transmitted on entire unlicensed carrier bandwidth resources based on pre-scheduling information, so the flexibility of data transmission may be improved. Moreover, from the above act, it may be concluded that data transmission may be executed by a group of terminals, therefore, the reuse rate of resources may be effectively improved. In addition, multiple terminals may transmit data at the same time, so that the efficiency of data exchange between a terminal and other nodes may be improved. Therefore, a problem of low reuse rate of resources may be solved, thereby achieving the effect of improving the reuse rate of resources.

In an exemplary embodiment, before the first group of terminals and/or the second group of terminals transmit data, the method may further include the following acts. The first group of terminals and/or the second group of terminals may perform CCA and/or eCCA detection. After detecting that a channel is clear, the first group of terminals and/or the second group of terminals may transmit an occupation signal.

Herein, the act that the first group of terminals and/or the second group of terminals perform CCA and/or eCCA detection may include one of the following acts. The first group of terminals and/or the second group of terminals may respectively perform CCA and/or eCCA detection on the CCA and/or eCCA resources pre-configured for the first group of terminals and/or the second group of terminals. The first group of terminals and/or the second group of terminals may perform CCA and/or eCCA detection on the entire unlicensed carrier bandwidth resources.

From the above acts, it may be concluded that each group of terminals may include multiple terminals. The multiple terminals in the same group may have a certain characteristic. In an exemplary embodiment, terminals in the first group of terminals may have at least one of the following characteristics: terminals in a same cell; terminals in different cells subordinate to a same operator; and UEs in different cells subordinate to different operators. In an exemplary embodiment, terminals in the second group of terminals may have at least one of the following characteristics: terminals in a same cell; terminals in different cells subordinate to a same operator; and UEs in different cells subordinate to different operators. Herein, after a certain terminal in one group obtains, through contention, some unlicensed carrier resources pre-configured or entire unlicensed carrier resources, other terminals in this group may transmit data by using the secured unlicensed carrier resources pre-configured or the entire unlicensed carrier resources. That is to say, a group of terminals may reuse the unlicensed carrier resources together.

There may be multiple configuration manners for the CCA and/or eCCA resources pre-configured. In an exemplary embodiment, the CCA and/or eCCA resources pre-configured for the first group of terminals and/or the second group of terminals may be configured by using at least one of the following manners. The CCA and/or eCCA resources may be configured by a base station. The CCA and/or eCCA resources may be configured via a negotiation between the first group of terminals and the second group of terminals.

There may be multiple manners for transmission of the occupation signal. In an exemplary embodiment, the act that the first group of terminals and/or the second group of terminals transmit the occupation signal may include one of the following acts. The first group of terminals and/or the second group of terminals may transmit an occupation signal on respective CCA and/or eCCA resources. The first group of terminals and/or the second group of terminals may transmit an occupation signal on the entire unlicensed carrier bandwidth resources.

Herein, the occupation signal transmitted by the first group of terminals and/or the second group of terminals may carry at least one of a group identifier, a cell identifier and an operator identifier. In an exemplary embodiment, the occupation signal transmitted by the first group of terminals and/or the second group of terminals may be in at least one of the following forms: an SRS, a preamble, a PSS/SSS, and a predetermined identifier.

In an exemplary embodiment, before the first group of terminals and/or the second group of terminals transmit the occupation signal on the entire unlicensed carrier bandwidth resources, the method may further include at least one of the following acts. A first terminal in the first group of terminals may determine that the first terminal and a second terminal which occupies the entire unlicensed carrier bandwidth resources in advance pertain to terminals in a same cell or different cells subordinate to a same operator. A third terminal in the second group of terminals may determine that the third terminal and a fourth terminal which occupies the entire unlicensed carrier bandwidth resources in advance pertain to terminals in a same cell or different cells subordinate to a same operator. In the exemplary embodiment, terminals in different groups may pertain to the same cell or the same operator.

Herein, when the first terminal determines that the first terminal and the second terminal pertain to terminals in the same cell or different cells subordinate to the same operator, the first terminal may determine whether a distance between the first terminal and the second terminal is greater than a first predetermined threshold and/or may determine whether a signal intensity, received by the first terminal, from the second terminal is smaller than a second predetermined threshold. If a determination result is positive, the first terminal may transmit the occupation signal, and otherwise, the first terminal may not transmit the occupation signal. Alternatively or additionally, when the third terminal determines that the third terminal and the fourth terminal pertain to terminals in the same cell or different cells subordinate to the same operator, the third terminal may determine whether a distance between the third terminal and the fourth terminal is greater than a first predetermined threshold and/or may determine whether a signal intensity, received by the third terminal, from the fourth terminal is smaller than a second predetermined threshold. If a determination result is positive, the third terminal may transmit the occupation signal, and otherwise, the third terminal may not transmit the occupation signal.

It should be noted that the occupation signal may satisfy a certain rule. In an exemplary embodiment, a proportion of the occupation signal to a transmission bandwidth may be greater than a predetermined proportion. In an exemplary embodiment, the proportion of the occupation signal to the transmission bandwidth may be enabled to be greater than the predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources. The proportion may be flexibly set as, for example, 80%.

In an exemplary embodiment, at least one of a CCA pattern, an eCCA pattern, a pattern of the occupation signal and a data transmission pattern may be indicated by pre-scheduling information. That is, pre-scheduling information may carry at least one of a CCA pattern, an eCCA pattern, a pattern of the occupation signal and a data transmission pattern.

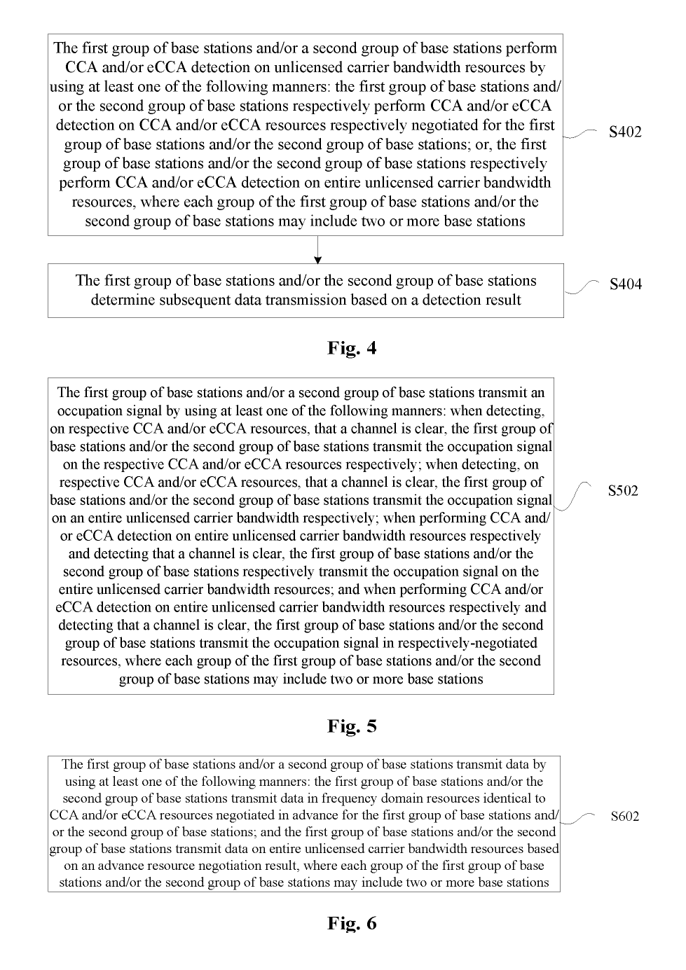

FIG. 4 is a flowchart of a third implementation of a data transmission method according to an embodiment of the present disclosure. As shown in FIG. 4, the method may include the acts S402 and S404 as follows.

At act S402, a first group of base stations and/or a second group of base stations may perform CCA and/or eCCA detection on unlicensed carrier bandwidth resources by using at least one of the following manners. The first group of base stations and/or the second group of base stations may respectively perform CCA and/or eCCA detection on CCA and/or eCCA resources respectively negotiated for the first group of base stations and/or the second group of base stations. The first group of base stations and/or the second group of base stations may respectively perform CCA and/or eCCA detection on entire unlicensed carrier bandwidth resources. In the embodiment, each group of the first group of base stations and/or the second group of base stations may include two or more base stations.

At act S404, the first group of base stations and/or the second group of base stations may determine subsequent data transmission based on a detection result.

By means of the above acts, a group of base stations may be adopted to perform CCA and/or eCCA detection on unlicensed carrier bandwidth resources, and subsequently, a group of base stations may be adopted to transmit data over a clear unlicensed carrier. Compared with a solution of adopting a single base station to perform CCA and/or eCCA detection for data transmission, the solution may effectively improve the reuse rate of resources, and may achieve an effect that multiple base stations may transmit data at the same time, thereby improving the efficiency of data exchange between a base station and other nodes. Therefore, a problem of low reuse rate of resources may be solved, thereby achieving the effect of improving the reuse rate of resources.

From the above acts, it may be concluded that each group of base stations may include multiple base stations. In some exemplary embodiments, the base stations in the same group may have a certain characteristic. In an exemplary embodiment, base stations in the first group of base stations may have at least one of the following characteristics: base stations subordinate to a same operator; and base stations subordinate to different operators. In an exemplary embodiment, base stations in the second group of base stations may have at least one of the following characteristics: base stations subordinate to a same operator; and base stations subordinate to different operators.

In an exemplary embodiment, after the first group of base stations and/or the second group of base stations perform CCA and/or eCCA detection on CCA and/or eCCA resources respectively negotiated for the first group of base stations and/or the second group of base stations, the method may further include the following acts. The first group of base stations and/or the second group of base stations may determine that a channel is clear. The first group of base stations and/or the second group of base stations may respectively transmit an occupation signal on the CCA and/or eCCA resources respectively negotiated for the first group of base stations and/or the second group of base stations; or, the first group of base stations and/or the second group of base stations may transmit an occupation signal on the entire unlicensed carrier bandwidth resources. The first group of base stations and/or the second group of base stations may determine subsequent data transmission based on the transmitted occupation signal. Herein, after a certain base station in one group obtains, through contention, some unlicensed carrier resources pre-configured or entire unlicensed carrier resources, other base stations in this group may transmit data by using the secured unlicensed carrier resources pre-configured or the entire unlicensed carrier resources. That is to say, a group of base stations may reuse the unlicensed carrier resources together.

After the first group of base stations and/or the second group of base stations respectively perform CCA and/or eCCA detection on entire unlicensed carrier bandwidth resources, the method may further include the following acts. The first group of base stations and/or the second group of base stations may determine that a channel is clear. After detecting that the channel is clear, the first group of base stations and/or the second group of base stations may respectively transmit an occupation signal on the entire unlicensed carrier bandwidth resources; or, after detecting that the channel is clear, the first group of base stations may transmit an occupation signal on the entire unlicensed carrier bandwidth resources, and when detecting that the channel is not clear, the second group of base stations may receive and parse the occupation signal transmitted by the first group of base stations.

Herein, the occupation signal transmitted by the first group of base stations and/or the second group of base stations may carry at least one of a group identifier, a cell identifier and an operator identifier. In an exemplary embodiment, the occupation signal transmitted by the first group of base stations and/or the second group of base stations may be in at least one of the following forms: an SRS, a preamble, a PSS/SSS, and a predetermined identifier.

In an exemplary embodiment, before the first group of base stations and/or the second group of base stations transmit the occupation signal on the entire unlicensed carrier bandwidth resources, the method may further include at least one of the following acts. A first base station in the first group of base stations may determine that the first base station and a second base station which occupies the entire unlicensed carrier bandwidth resources in advance pertain to base stations subordinate to a same operator. A third base station in the second group of base stations may determine that the third base station and a fourth base station which occupies the entire unlicensed carrier bandwidth resources in advance pertain to base stations subordinate to a same operator. In some exemplary embodiment, base stations in different groups may pertain to the same operator.

Herein, when the first base station determines that the first base station and the second base station pertain to base stations subordinate to the same operator, the first base station may determine whether a distance between the first base station and the second base station is greater than a first predetermined threshold and/or may determine whether a signal intensity, received by the first base station, from the second base station is smaller than a second predetermined threshold. If a determination result is positive, the first base station may transmit the occupation signal, and otherwise, the first base station may not transmit the occupation signal. Alternatively or additionally, when the third base station determines that the third base station and the fourth base station pertain to base stations subordinate to the same operator, the third base station may determine whether a distance between the third base station and the fourth base station is greater than a first predetermined threshold and/or may determine whether a signal intensity, received by the third base station, from the fourth base station is smaller than a second predetermined threshold. If a determination result is positive, the third base station may transmit the occupation signal, and otherwise, the third base station may not transmit the occupation signal.

It should be noted that the occupation signal may satisfy a certain rule. In an exemplary embodiment, a proportion of the occupation signal to a transmission bandwidth may be greater than a predetermined proportion. In an exemplary embodiment, the proportion of the occupation signal to the transmission bandwidth may be enabled to be greater than the predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources. The proportion may be flexibly set as, for example, 80%.

In an exemplary embodiment, at least one of a CCA pattern, an eCCA pattern, a pattern of the occupation signal and a data transmission pattern may be indicated by pre-scheduling information. That is, pre-scheduling information may carry at least one of a CCA pattern, an eCCA pattern, a pattern of the occupation signal and a data transmission pattern.

FIG. 5 is a flowchart of a second implementation of an occupation signal transmission method according to an embodiment of the present disclosure. As shown in FIG. 5, the method may include the act S502 as follows.

At act S502, a first group of base stations and/or a second group of base stations may transmit an occupation signal by using at least one of the following manners. When detecting, on respective CCA and/or eCCA resources, that a channel is clear, the first group of base stations and/or the second group of base stations may transmit an occupation signal on the respective CCA and/or eCCA resources respectively. When detecting, on respective CCA and/or eCCA resources, that a channel is clear, the first group of base stations and/or the second group of base stations may transmit an occupation signal on an entire unlicensed carrier bandwidth respectively. When performing CCA and/or eCCA detection on entire unlicensed carrier bandwidth resources respectively and detecting that a channel is clear, the first group of base stations and/or the second group of base stations may respectively transmit an occupation signal on the entire unlicensed carrier bandwidth resources. When performing CCA and/or eCCA detection on entire unlicensed carrier bandwidth resources respectively and detecting that a channel is clear, the first group of base stations and/or the second group of base stations may transmit an occupation signal in respectively-negotiated resources. In the embodiment, each group of the first group of base stations and/or the second group of base stations may include two or more base stations.

By means of the above act, when detecting whether a channel is clear, a base station in one group may detect whether entire unlicensed carrier resources are clear, and may alternatively detect whether respective CCA and/or eCCA resources are clear. Moreover, each checking manner may correspond to two occupation signal transmission manners: 1, transmitting an occupation signal over an entire unlicensed carrier bandwidth, and 2, transmitting an occupation signal on respective CCA and/or eCCA resources. Moreover, from the above act, it may be concluded that both detection and occupation signal transmission may be executed by a group of base stations, therefore, the reuse rate of resources may be effectively improved. In addition, multiple base stations may transmit data at the same time, so that the efficiency of data exchange between a base station and other nodes may be improved. Therefore, a problem of low reuse rate of resources may be solved, thereby achieving the effect of improving the reuse rate of resources.

In an exemplary embodiment, the occupation signal transmitted by the first group of base stations and/or the second group of base stations may carry at least one of a group identifier, a cell identifier and an operator identifier. In an exemplary embodiment, the occupation signal transmitted by the first group of base stations and/or the second group of base stations may be in at least one of the following forms: an SRS, a preamble, a PSS/SSS, and a predetermined identifier.

Herein, before the first group of base stations and/or the second group of base stations transmit the occupation signal, the method may further include at least one of the following acts. The first group of base stations and/or the second group of base stations may respectively perform CCA and/or eCCA detection on CCA and/or eCCA resources respectively negotiated for the first group of base stations and/or the second group of base stations. The first group of base stations and/or the second group of base stations may respectively perform CCA and/or eCCA detection on entire unlicensed carrier bandwidth resources.

From the above acts, it may be concluded that each group of base stations may include multiple base stations. In some exemplary embodiments, the base stations in the same group may have a certain characteristic. In an exemplary embodiment, base stations in the first group of base stations may have at least one of the following characteristics: base stations subordinate to a same operator; and base stations subordinate to different operators. In an exemplary embodiment, base stations in the second group of base stations may have at least one of the following characteristics: base stations subordinate to a same operator; and base stations subordinate to different operators. Herein, after a certain base station in one group obtains, through contention, some unlicensed carrier resources pre-configured or entire unlicensed carrier resources, other base stations in this group may transmit data by using the secured unlicensed carrier resources pre-configured or the entire unlicensed carrier resources. That is to say, a group of base stations may reuse the unlicensed carrier resources together.

In an exemplary embodiment, after the first group of base stations and/or the second group of base stations transmit the occupation signal, the method may further include the following act. Data may be transmitted based on configured CCA and/or eCCA resources.

In an exemplary embodiment, the act that the first group of base stations and/or the second group of base stations transmit the occupation signal on entire unlicensed carrier bandwidth resources may include one of the following acts. After the first group of base stations and/or the second group of base stations detect that a channel is clear, the first group of base stations and/or the second group of base stations may transmit an occupation signal on the entire unlicensed carrier bandwidth resources. After detecting that a channel is clear, the first group of base stations may transmit an occupation signal on the entire unlicensed carrier bandwidth resources, and when detecting that the channel is not clear, the second group of base stations may receive and parse the occupation signal transmitted by the first group of base stations.

Herein, before the first group of base stations and/or the second group of base stations transmit the occupation signal on entire unlicensed carrier bandwidth resources, the method may further include at least one of the following acts. A first base station in the first group of base stations may determine that the first base station and a second base station which occupies the entire unlicensed carrier bandwidth resources in advance pertain to base stations subordinate to a same operator. A third base station in the second group of base stations may determine that the third base station and a fourth base station which occupies the entire unlicensed carrier bandwidth resources in advance pertain to base stations subordinate to a same operator. In some exemplary embodiment, base stations in different groups may pertain to the same operator.

Herein, when the first base station determines that the first base station and the second base station pertain to base stations subordinate to the same operator, the first base station may determine whether a distance between the first base station and the second base station is greater than a first predetermined threshold and/or may determine whether a signal intensity, received by the first base station, from the second base station is smaller than a second predetermined threshold. If a determination result is positive, the first base station may transmit the occupation signal, and otherwise, the first base station may not transmit the occupation signal. Alternatively or additionally, when the third base station determines that the third base station and the fourth base station pertain to base stations subordinate to the same operator, the third base station may determine whether a distance between the third base station and the fourth base station is greater than a first predetermined threshold and/or may determine whether a signal intensity, received by the third base station, from the fourth base station is smaller than a second predetermined threshold. If a determination result is positive, the third base station may transmit the occupation signal, and otherwise, the third base station may not transmit the occupation signal.

It should be noted that the occupation signal may satisfy a certain rule. In an exemplary embodiment, a proportion of the occupation signal to a transmission bandwidth may be greater than a predetermined proportion. In an exemplary embodiment, the proportion of the occupation signal to the transmission bandwidth may be enabled to be greater than the predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources. The proportion may be flexibly set as, for example, 80%.

In an exemplary embodiment, at least one of a CCA pattern, an eCCA pattern, a pattern of the occupation signal and a data transmission pattern may be indicated by pre-scheduling information. That is, pre-scheduling information may carry at least one of a CCA pattern, an eCCA pattern, a pattern of the occupation signal and a data transmission pattern.

FIG. 6 is a flowchart of a fourth implementation of a data transmission method according to an embodiment of the present disclosure. As shown in FIG. 6, the method may include the act S602 as follows.

At act S602, a first group of base stations and/or a second group of base stations may transmit data by using at least one of the following manners. The first group of base stations and/or the second group of base stations may transmit data in frequency domain resources identical to CCA and/or eCCA resources negotiated in advance for the first group of base stations and/or the second group of base stations. The first group of base stations and/or the second group of base stations may transmit data on entire unlicensed carrier bandwidth resources based on an advance resource negotiation result. In the embodiment, each group of the first group of base stations and/or the second group of base stations may include two or more base stations.

By means of the above act, it may be concluded that during data transmission of each group of base stations, there may be two transmission manners, for example, data may be transmitted in frequency domain resources identical to CCA and/or eCCA resources pre-configured for the group of base stations or may be transmitted on entire unlicensed carrier bandwidth resources based on pre-scheduling information, so the flexibility of data transmission may be improved. Moreover, from the above act, it may be concluded that data transmission may be executed by a group of base stations, therefore, the reuse rate of resources may be effectively improved. In addition, multiple base stations may transmit data at the same time, so that the efficiency of data exchange between a base station and other nodes may be improved. Therefore, a problem of low reuse rate of resources may be solved, thereby achieving the effect of improving the reuse rate of resources.

From the above act, it may be concluded that each group of base stations may include multiple base stations. In some exemplary embodiments, the base stations in the same group may have a certain characteristic. In an exemplary embodiment, base stations in the first group of base stations may have at least one of the following characteristics: base stations subordinate to a same operator; and base stations subordinate to different operators. In an exemplary embodiment, base stations in the second group of base stations may have at least one of the following characteristics: base stations subordinate to a same operator; and base stations subordinate to different operators. Herein, after a certain base station in one group obtains, through contention, some unlicensed carrier resources pre-configured or entire unlicensed carrier resources, other base stations in this group may transmit data by using the secured unlicensed carrier resources pre-configured or the entire unlicensed carrier resources. That is to say, a group of base stations may reuse the unlicensed carrier resources together.

In an exemplary embodiment, before the first group of base stations and/or the second group of base stations transmit data, the method may further include the following acts. The first group of base stations and/or the second group of base stations may perform CCA and/or eCCA detection. After detecting that a channel is clear, the first group of base stations and/or the second group of base stations may transmit an occupation signal.

Herein, the act that the first group of base stations and/or the second group of base stations perform CCA and/or eCCA detection may include one of the following acts. The first group of base stations and/or the second group of base stations may respectively perform CCA and/or eCCA detection on the CCA and/or eCCA resources negotiated in advance for the first group of base stations and/or the second group of base stations. The first group of base stations and/or the second group of base stations may perform CCA and/or eCCA detection on the entire unlicensed carrier bandwidth resources.

There may be multiple manners for transmission of the occupation signal. In an exemplary embodiment, the act that the first group of base stations and/or the second group of base stations transmit the occupation signal may include one of the following acts. The first group of base stations and/or the second group of base stations may transmit an occupation signal on the CCA and/or eCCA resources negotiated in advance. The first group of base stations and/or the second group of base stations may transmit an occupation signal on the entire unlicensed carrier bandwidth resources.

Herein, the occupation signal transmitted by the first group of base stations and/or the second group of base stations may carry at least one of a group identifier, a cell identifier and an operator identifier. In an exemplary embodiment, the occupation signal transmitted by the first group of base stations and/or the second group of base stations may be in at least one of the following forms: an SRS, a preamble, a PSS/SSS, and a predetermined identifier.

In an exemplary embodiment, before the first group of base stations and/or the second group of base stations transmit the occupation signal on the entire unlicensed carrier bandwidth resources, the method may further include at least one of the following acts. A first base station in the first group of base stations may determine that the first base station and a second base station which occupies the entire unlicensed carrier bandwidth resources in advance pertain to base stations subordinate to a same operator. A third base station in the second group of base stations may determine that the third base station and a fourth base station which occupies the entire unlicensed carrier bandwidth resources in advance pertain to base stations subordinate to a same operator. In some exemplary embodiment, base stations in different groups may pertain to the same operator.

Herein, when the first base station determines that the first base station and the second base station pertain to base stations subordinate to the same operator, the first base station may determine whether a distance between the first base station and the second base station is greater than a first predetermined threshold and/or may determine whether a signal intensity, received by the first base station, from the second base station is smaller than a second predetermined threshold. If a determination result is positive, the first base station may transmit the occupation signal, and otherwise, the first base station may not transmit the occupation signal. Alternatively or additionally, when the third base station determines that the third base station and the fourth base station pertain to base stations subordinate to the same operator, the third base station may determine whether a distance between the third base station and the fourth base station is greater than a first predetermined threshold and/or may determine whether a signal intensity, received by the third base station, from the fourth base station is smaller than a second predetermined threshold. If a determination result is positive, the third base station may transmit the occupation signal, and otherwise, the third base station may not transmit the occupation signal.

It should be noted that the occupation signal may satisfy a certain rule. In an exemplary embodiment, a proportion of the occupation signal to a transmission bandwidth may be greater than a predetermined proportion. In an exemplary embodiment, the proportion of the occupation signal to the transmission bandwidth may be enabled to be greater than the predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources. The proportion may be flexibly set as, for example, 80%.

In an exemplary embodiment, at least one of a CCA pattern, an eCCA pattern, a pattern of the occupation signal and a data transmission pattern may be indicated by pre-scheduling information. That is, pre-scheduling information may carry at least one of a CCA pattern, an eCCA pattern, a pattern of the occupation signal and a data transmission pattern.

By means of the above description for the implementation manner, a person skilled in the art can clearly know that the method based on the abovementioned embodiments may be implemented by means of software and a necessary general hardware platform, or may be implemented through hardware. In the two example implementation, the former may be a better implementation manner under many circumstances. Based on such understanding, the solutions of the present disclosure may be substantially embodied in a form of software product or parts contributing to the traditional art or all or some of the solutions may be embodied in a form of software product. A computer software product may be stored in a storage medium (such as a Read-Only Memory/Random Access Memory (ROM/RAM), a magnetic disk and an optical disk), including a plurality of instructions enabling terminal equipment (which may be a mobile phone, a computer, a server or network equipment) to execute the method based on each embodiment of the present disclosure.

In the present embodiment, an unlicensed carrier occupation device is also provided. The device is used to implement the abovementioned embodiments and preferable implementation manner. Those which have been illustrated will not be elaborated herein. Just as a term ‘module’ used below, the combination of software and/or hardware with predetermined functions may be implemented. Although the device described by the following embodiment may be better implemented by software, the implementation of hardware or the combination of software and hardware may be possible and conceived.

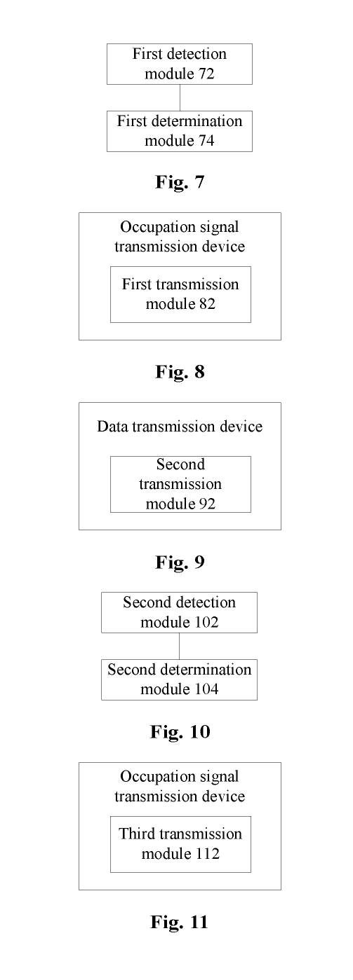

FIG. 7 is a block diagram of a first implementation of a data transmission device according to an embodiment of the present disclosure. The device may be applied to a first group of terminals and/or a second group of terminals. As shown in FIG. 7, the device may include a first detection module 72 and a first determination module 74. The device will be illustrated hereinbelow.

The first detection module 72 may be configured to perform CCA and/or eCCA detection on unlicensed carrier bandwidth resources by using at least one of the following manners. The first group of terminals and/or the second group of terminals may respectively perform CCA and/or eCCA detection on CCA and/or eCCA resources pre-configured for the first group of terminals and/or the second group of terminals. The first group of terminals and/or the second group of terminals may respectively perform CCA and/or eCCA detection on entire unlicensed carrier bandwidth resources. In this embodiment, each group of the first group of terminals and/or the second group of terminals may include two or more terminals. The first determination module 74 may be coupled to the first detection module 72, and may be configured to determine subsequent data transmission based on a detection result.

It can thus be seen that each group of terminals may include multiple terminals. The multiple terminals in the same group may have a certain characteristic. In an exemplary embodiment, terminals in the first group of terminals may have at least one of the following characteristics: terminals in a same cell; terminals in different cells subordinate to a same operator; and UEs in different cells subordinate to different operators. In an exemplary embodiment, terminals in the second group of terminals may have at least one of the following characteristics: terminals in a same cell; terminals in different cells subordinate to a same operator; and UEs in different cells subordinate to different operators.

There may be multiple configuration manners for the CCA and/or eCCA resources pre-configured. In an exemplary embodiment, the CCA and/or eCCA resources pre-configured for the first group of terminals and/or the second group of terminals may be configured by using at least one of the following manners. The CCA and/or eCCA resources may be configured by a base station. The CCA and/or eCCA resources may be configured via a negotiation between the first group of terminals and the second group of terminals.

Herein, the device may further include a relevant transmission module. The relevant transmission module may be configured to transmit, if the first group of terminals and/or the second group of terminals discover that a channel is clear after performing CCA and/or eCCA detection on the pre-configured CCA and/or eCCA resources, an occupation signal for occupying the clear channel. The operation may be implemented in the following manner. The first group of terminals and/or the second group of terminals may determine that the channel is clear. The first group of terminals and/or the second group of terminals may respectively transmit an occupation signal on unlicensed carrier bandwidth resources subjected to CCA and/or eCCA detection; or, the first group of terminals and/or the second group of terminals may respectively transmit an occupation signal on the entire unlicensed carrier bandwidth resources. The first group of terminals and/or the second group of terminals may determine subsequent data transmission based on the transmitted occupation signal. Herein, after a certain terminal in one group obtains, through contention, some unlicensed carrier resources pre-configured or entire unlicensed carrier resources, other terminals in this group may transmit data by using the secured unlicensed carrier resources pre-configured or the entire unlicensed carrier resources. That is to say, a group of terminals may reuse the unlicensed carrier resources together.

In an exemplary embodiment, after the first group of terminals and/or the second group of terminals respectively perform CCA and/or eCCA detection on the entire unlicensed carrier bandwidth resources, the solution may include the following acts. The first group of terminals and/or the second group of terminals may detect that a channel is clear. After detecting that the channel is clear, the first group of terminals and/or the second group of terminals may respectively transmit an occupation signal on the entire unlicensed carrier bandwidth resources; or, after detecting that the channel is clear, the first group of terminals may transmit an occupation signal on the entire unlicensed carrier bandwidth resources, and when detecting that the channel is not clear, the second group of terminals may receive and parse the occupation signal transmitted by the first group of terminals.

Herein, the occupation signal transmitted by the first group of terminals and/or the second group of terminals may carry at least one of a group identifier, a cell identifier and an operator identifier. In an exemplary embodiment, the occupation signal transmitted by the first group of terminals and/or the second group of terminals may be in at least one of the following forms: an SRS, a preamble, a PSS/SSS, and a predetermined identifier.

In an exemplary embodiment, the device may further include a relevant determination module. The relevant determination module may be configured to: enable, before the first group of terminals and/or the second group of terminals transmit the occupation signal on the entire unlicensed carrier bandwidth resources, a first terminal in the first group of terminals to determine that the first terminal and a second terminal which occupies the entire unlicensed carrier bandwidth resources in advance pertain to terminals in a same cell or different cells subordinate to a same operator; and/or, enable a third terminal in the second group of terminals to determine that the third terminal and a fourth terminal which occupies the entire unlicensed carrier bandwidth resources in advance pertain to terminals in a same cell or different cells subordinate to a same operator. In the exemplary embodiment, terminals in different groups may pertain to the same cell or the same operator.

Herein, when the first terminal determines that the first terminal and the second terminal pertain to terminals in the same cell or different cells subordinate to the same operator, the first terminal may determine whether a distance between the first terminal and the second terminal is greater than a first predetermined threshold and/or may determine whether a signal intensity, received by the first terminal, from the second terminal is smaller than a second predetermined threshold. If a determination result is positive, the first terminal may transmit the occupation signal, and otherwise, the first terminal may not transmit the occupation signal. Alternatively or additionally, when the third terminal determines that the third terminal and the fourth terminal pertain to terminals in the same cell or different cells subordinate to the same operator, the third terminal may determine whether a distance between the third terminal and the fourth terminal is greater than a first predetermined threshold and/or may determine whether a signal intensity, received by the third terminal, from the fourth terminal is smaller than a second predetermined threshold. If a determination result is positive, the third terminal may transmit the occupation signal, and otherwise, the third terminal may not transmit the occupation signal.

It should be noted that the occupation signal may satisfy a certain rule. In an exemplary embodiment, a proportion of the occupation signal to a transmission bandwidth may be greater than a predetermined proportion. In an exemplary embodiment, the proportion of the occupation signal to the transmission bandwidth may be enabled to be greater than the predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources. The proportion may be flexibly set as, for example, 80%.

In an exemplary embodiment, at least one of a CCA pattern, an eCCA pattern, a pattern of the occupation signal and a data transmission pattern may be indicated by pre-scheduling information. That is, pre-scheduling information may carry at least one of a CCA pattern, an eCCA pattern, a pattern of the occupation signal and a data transmission pattern.

FIG. 8 illustrates a first implementation of an occupation signal transmission device according to an embodiment of the present disclosure. The device may be applied to a first group of terminals and/or a second group of terminals. As shown in FIG. 8, the device may include a first transmission module 82. The device will be illustrated hereinbelow.

The first transmission module 82 may be configured to transmit an occupation signal by using at least one of the following manners. When detecting, on respective CCA and/or eCCA resources, that a channel is clear, the first group of terminals and/or the second group of terminals may transmit an occupation signal on the respective CCA and/or eCCA resources respectively. When detecting, on respective CCA and/or eCCA resources, that a channel is clear, the first group of terminals and/or the second group of terminals may transmit an occupation signal on an entire unlicensed carrier bandwidth respectively. When performing CCA and/or eCCA detection on entire unlicensed carrier bandwidth resources respectively and detecting that a channel is clear, the first group of terminals and/or the second group of terminals may respectively transmit an occupation signal on the entire unlicensed carrier bandwidth resources. When performing CCA and/or eCCA detection on entire unlicensed carrier bandwidth resources respectively and detecting that a channel is clear, the first group of terminals and/or the second group of terminals may transmit an occupation signal on respective CCA and/or eCCA resources respectively. In this embodiment, each group of the first group of terminals and/or the second group of terminals may include two or more terminals.

In an exemplary embodiment, the occupation signal transmitted by the first group of terminals and/or the second group of terminals may carry at least one of a group identifier, a cell identifier and an operator identifier. In an exemplary embodiment, the occupation signal transmitted by the first group of terminals and/or the second group of terminals may be in at least one of the following forms: an SRS, a preamble, a PSS/SSS, and a predetermined identifier.

Herein, before the first group of terminals and/or the second group of terminals transmit the occupation signal, CCA and/or eCCA detection may be performed by a detection module first. The detection module may perform at least one of the following acts. The first group of terminals and/or the second group of terminals may respectively perform CCA and/or eCCA detection on CCA and/or eCCA resources pre-configured for the first group of terminals and/or the second group of terminals. The first group of terminals and/or the second group of terminals may respectively perform CCA and/or eCCA detection on entire unlicensed carrier bandwidth resources.

It can thus be seen that each group of terminals may include multiple terminals. The multiple terminals in the same group may have a certain characteristic. In an exemplary embodiment, terminals in the first group of terminals may have at least one of the following characteristics: terminals in a same cell; terminals in different cells subordinate to a same operator; and UEs in different cells subordinate to different operators. In an exemplary embodiment, terminals in the second group of terminals may have at least one of the following characteristics: terminals in a same cell; terminals in different cells subordinate to a same operator; and UEs in different cells subordinate to different operators. Herein, after a certain terminal in one group obtains, through contention, some unlicensed carrier resources pre-configured or entire unlicensed carrier resources, other terminals in this group may transmit data by using the secured unlicensed carrier resources pre-configured or the entire unlicensed carrier resources. That is to say, a group of terminals may reuse the unlicensed carrier resources together.

There may be multiple configuration manners for the CCA and/or eCCA resources pre-configured. In an exemplary embodiment, the CCA and/or eCCA resources pre-configured for the first group of terminals and/or the second group of terminals may be configured by using at least one of the following manners. The CCA and/or eCCA resources may be configured by a base station. The CCA and/or eCCA resources may be configured via a negotiation between the first group of terminals and the second group of terminals.

In an exemplary embodiment, the device may further include a relevant transmission module. The relevant transmission module may be configured to: transmit data based on configured CCA and/or eCCA resources; and/or, transmit data based on pre-scheduling information.

The first group of terminals and/or the second group of terminals may transmit the occupation signal on entire unlicensed carrier bandwidth resources in one of the following manners. After the first group of terminals and/or the second group of terminals detect that a channel is clear, the first group of terminals and/or the second group of terminals may transmit an occupation signal on the entire unlicensed carrier bandwidth resources. After detecting that a channel is clear, the first group of terminals may transmit an occupation signal on the entire unlicensed carrier bandwidth resources, and when detecting that the channel is not clear, the second group of terminals may receive and parse the occupation signal transmitted by the first group of terminals.

In an exemplary embodiment, the device may further include a relevant transmission module. The relevant transmission module may be configured to: enable, before the first group of terminals and/or the second group of terminals transmit the occupation signal on entire unlicensed carrier bandwidth resources, a first terminal in the first group of terminals to determine that the first terminal and a second terminal which occupies the entire unlicensed carrier bandwidth resources in advance pertain to terminals in a same cell or different cells subordinate to a same operator; and/or, enable a third terminal in the second group of terminals to determine that the third terminal and a fourth terminal which occupies the entire unlicensed carrier bandwidth resources in advance pertain to terminals in a same cell or different cells subordinate to a same operator. In the exemplary embodiment, terminals in different groups may pertain to the same cell or the same operator.

Herein, when the first terminal determines that the first terminal and the second terminal pertain to terminals in the same cell or different cells subordinate to the same operator, the first terminal may determine whether a distance between the first terminal and the second terminal is greater than a first predetermined threshold and/or may determine whether a signal intensity, received by the first terminal, from the second terminal is smaller than a second predetermined threshold. If a determination result is positive, the first terminal may transmit the occupation signal, and otherwise, the first terminal may not transmit the occupation signal. Alternatively or additionally, when the third terminal determines that the third terminal and the fourth terminal pertain to terminals in the same cell or different cells subordinate to the same operator, the third terminal may determine whether a distance between the third terminal and the fourth terminal is greater than a first predetermined threshold and/or may determine whether a signal intensity, received by the third terminal, from the fourth terminal is smaller than a second predetermined threshold. If a determination result is positive, the third terminal may transmit the occupation signal, and otherwise, the third terminal may not transmit the occupation signal.

It should be noted that the occupation signal may satisfy a certain rule. In an exemplary embodiment, a proportion of the occupation signal to a transmission bandwidth may be greater than a predetermined proportion. In an exemplary embodiment, the proportion of the occupation signal to the transmission bandwidth may be enabled to be greater than the predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources. The proportion may be flexibly set as, for example, 80%.

In an exemplary embodiment, at least one of a CCA pattern, an eCCA pattern, a pattern of the occupation signal and a data transmission pattern may be indicated by pre-scheduling information. That is, pre-scheduling information may carry at least one of a CCA pattern, an eCCA pattern, a pattern of the occupation signal and a data transmission pattern.

FIG. 9 is a block diagram of a second implementation of a data transmission device according to an embodiment of the present disclosure. The device may be applied to a first group of terminals and/or a second group of terminals. As shown in FIG. 9, the device may include a second transmission module 92. The device will be illustrated hereinbelow.

The second transmission module 92 may be configured to transmit data by using at least one of the following manners. The first group of terminals and/or the second group of terminals may transmit data in frequency domain resources identical to CCA and/or eCCA resources pre-configured for the first group of terminals and/or the second group of terminals. The first group of terminals and/or the second group of terminals may transmit data on entire unlicensed carrier bandwidth resources based on pre-scheduling information. In this embodiment, each group of the first group of terminals and/or the second group of terminals may include two or more terminals.

In an exemplary embodiment, the device may further include a relevant detection and transmission module. The relevant detection and transmission module may be configured to: enable, before the first group of terminals and/or the second group of terminals transmit data, the first group of terminals and/or the second group of terminals to perform CCA and/or eCCA detection; and transmit, after the first group of terminals and/or the second group of terminals detect that a channel is clear, an occupation signal.

Herein, a checking module may be configured to: enable the first group of terminals and/or the second group of terminals to respectively perform CCA and/or eCCA detection on the CCA and/or eCCA resources pre-configured for the first group of terminals and/or the second group of terminals; or enable the first group of terminals and/or the second group of terminals to perform CCA and/or eCCA detection on the entire unlicensed carrier bandwidth resources.

It can thus be seen that each group of terminals may include multiple terminals. The multiple terminals in the same group may have a certain characteristic. In an exemplary embodiment, terminals in the first group of terminals may have at least one of the following characteristics: terminals in a same cell; terminals in different cells subordinate to a same operator; and UEs in different cells subordinate to different operators. In an exemplary embodiment, terminals in the second group of terminals may have at least one of the following characteristics: terminals in a same cell; terminals in different cells subordinate to a same operator; and UEs in different cells subordinate to different operators. Herein, after a certain terminal in one group obtains, through contention, some unlicensed carrier resources pre-configured or entire unlicensed carrier resources, other terminals in this group may transmit data by using the secured unlicensed carrier resources pre-configured or the entire unlicensed carrier resources. That is to say, a group of terminals may reuse the unlicensed carrier resources together.

There may be multiple configuration manners for the CCA and/or eCCA resources pre-configured. In an exemplary embodiment, the CCA and/or eCCA resources pre-configured for the first group of terminals and/or the second group of terminals may be configured by using at least one of the following manners. The CCA and/or eCCA resources may be configured by a base station. The CCA and/or eCCA resources may be configured via a negotiation between the first group of terminals and the second group of terminals.

There may be multiple manners for transmission of the occupation signal. In an exemplary embodiment, the first group of terminals and/or the second group of terminals may transmit the occupation signal in one of the following manners. The first group of terminals and/or the second group of terminals may transmit an occupation signal on respective CCA and/or eCCA resources. The first group of terminals and/or the second group of terminals may transmit an occupation signal on the entire unlicensed carrier bandwidth resources.

Herein, the occupation signal transmitted by the first group of terminals and/or the second group of terminals may carry at least one of a group identifier, a cell identifier and an operator identifier. In an exemplary embodiment, the occupation signal transmitted by the first group of terminals and/or the second group of terminals may be in at least one of the following forms: an SRS, a preamble, a PSS/SSS, and a predetermined identifier.

In an exemplary embodiment, the device may further include a relevant transmission module. The relevant transmission module may be configured to: enable, before the first group of terminals and/or the second group of terminals transmit an occupation signal on the entire unlicensed carrier bandwidth resources, a first terminal in the first group of terminals to determine that the first terminal and a second terminal which occupies the entire unlicensed carrier bandwidth resources in advance pertain to terminals in a same cell or different cells subordinate to a same operator; and/or, enable a third terminal in the second group of terminals to determine that the third terminal and a fourth terminal which occupies the entire unlicensed carrier bandwidth resources in advance pertain to terminals in a same cell or different cells subordinate to a same operator. In the exemplary embodiment, terminals in different groups may pertain to the same cell or the same operator.

Herein, when the first terminal determines that the first terminal and the second terminal pertain to terminals in the same cell or different cells subordinate to the same operator, the first terminal may determine whether a distance between the first terminal and the second terminal is greater than a first predetermined threshold and/or may determine whether a signal intensity, received by the first terminal, from the second terminal is smaller than a second predetermined threshold. If a determination result is positive, the first terminal may transmit the occupation signal, and otherwise, the first terminal may not transmit the occupation signal. Alternatively or additionally, when the third terminal determines that the third terminal and the fourth terminal pertain to terminals in the same cell or different cells subordinate to the same operator, the third terminal may determine whether a distance between the third terminal and the fourth terminal is greater than a first predetermined threshold and/or may determine whether a signal intensity, received by the third terminal, from the fourth terminal is smaller than a second predetermined threshold. If a determination result is positive, the third terminal may transmit the occupation signal, and otherwise, the third terminal may not transmit the occupation signal.

It should be noted that the occupation signal may satisfy a certain rule. In an exemplary embodiment, a proportion of the occupation signal to a transmission bandwidth may be greater than a predetermined proportion. In an exemplary embodiment, the proportion of the occupation signal to the transmission bandwidth may be enabled to be greater than the predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources. The proportion may be flexibly set as, for example, 80%.

In an exemplary embodiment, at least one of a CCA pattern, an eCCA pattern, a pattern of the occupation signal and a data transmission pattern may be indicated by pre-scheduling information. That is, pre-scheduling information may carry at least one of a CCA pattern, an eCCA pattern, a pattern of the occupation signal and a data transmission pattern.

FIG. 10 is a block diagram of a third implementation of a data transmission device according to an embodiment of the present disclosure. The device may be applied to a first group of base stations and/or a second group of base stations. As shown in FIG. 10, the device may include a second detection module 102 and a second determination module 104. The device will be illustrated hereinbelow.

The second detection module 102 may be configured to perform CCA and/or eCCA detection on unlicensed carrier bandwidth resources by using at least one of the following manners. The first group of base stations and/or the second group of base stations may respectively perform CCA and/or eCCA detection on CCA and/or eCCA resources respectively negotiated for the first group of base stations and/or the second group of base stations. The first group of base stations and/or the second group of base stations may respectively perform CCA and/or eCCA detection on entire unlicensed carrier bandwidth resources. In this embodiment, each group of the first group of base stations and/or the second group of base stations may include two or more base stations. The second determination module 104 may be coupled to the second detection module 102, and may be configured to determine subsequent data transmission based on a detection result.

It can thus be seen that each group of base stations may include multiple base stations. In some exemplary embodiments, the base stations in the same group may have a certain characteristic. In an exemplary embodiment, base stations in the first group of base stations may have at least one of the following characteristics: base stations subordinate to a same operator; and base stations subordinate to different operators. In an exemplary embodiment, base stations in the second group of base stations may have at least one of the following characteristics: base stations subordinate to a same operator; and base stations subordinate to different operators.

In an exemplary embodiment, the device may further include a relevant transmission module. The relevant transmission module may be configured to: enable the first group of base stations and/or the second group of base stations to perform CCA and/or eCCA detection on CCA and/or eCCA resources respectively negotiated for the first group of base stations and/or the second group of base stations, then to determine that a channel is clear, and to respectively transmit an occupation signal on the CCA and/or eCCA resources respectively negotiated for the first group of base stations and/or the second group of base stations; or, enable the first group of base stations and/or the second group of base stations to transmit an occupation signal on the entire unlicensed carrier bandwidth resources, and enable the first group of base stations and/or the second group of base stations to determine subsequent data transmission based on the transmitted occupation signal. Herein, after a certain base station in one group obtains, through contention, some unlicensed carrier resources pre-configured or entire unlicensed carrier resources, other base stations in this group may transmit data by using the secured unlicensed carrier resources pre-configured or the entire unlicensed carrier resources. That is to say, a group of base stations may reuse the unlicensed carrier resources together.

After the first group of base stations and/or the second group of base stations respectively perform CCA and/or eCCA detection on entire unlicensed carrier bandwidth resources, the method may further include the following acts. The first group of base stations and/or the second group of base stations may determine that a channel is clear. After detecting that the channel is clear, the first group of base stations and/or the second group of base stations may respectively transmit an occupation signal on the entire unlicensed carrier bandwidth resources; or, after detecting that the channel is clear, the first group of base stations may transmit an occupation signal on the entire unlicensed carrier bandwidth resources, and when detecting that the channel is not clear, the second group of base stations may receive and parse the occupation signal transmitted by the first group of base stations.

Herein, the occupation signal transmitted by the first group of base stations and/or the second group of base stations may carry at least one of a group identifier, a cell identifier and an operator identifier. In an exemplary embodiment, the occupation signal transmitted by the first group of base stations and/or the second group of base stations may be in at least one of the following forms: an SRS, a preamble, a PSS/SSS, and a predetermined identifier.

In an exemplary embodiment, the device may further include a relevant determination module. The relevant determination module may be configured to: enable, before the first group of base stations and/or the second group of base stations transmit the occupation signal on the entire unlicensed carrier bandwidth resources, a first base station in the first group of base stations to determine that the first base station and a second base station which occupies the entire unlicensed carrier bandwidth resources in advance pertain to base stations subordinate to a same operator; and/or, enable a third base station in the second group of base stations to determine that the third base station and a fourth base station which occupies the entire unlicensed carrier bandwidth resources in advance pertain to base stations subordinate to a same operator. In some exemplary embodiment, base stations in different groups may pertain to the same operator.

Herein, when the first base station determines that the first base station and the second base station pertain to base stations subordinate to the same operator, the first base station may determine whether a distance between the first base station and the second base station is greater than a first predetermined threshold and/or may determine whether a signal intensity, received by the first base station, from the second base station is smaller than a second predetermined threshold. If a determination result is positive, the first base station may transmit the occupation signal, and otherwise, the first base station may not transmit the occupation signal. Alternatively or additionally, when the third base station determines that the third base station and the fourth base station pertain to base stations subordinate to the same operator, the third base station may determine whether a distance between the third base station and the fourth base station is greater than a first predetermined threshold and/or may determine whether a signal intensity, received by the third base station, from the fourth base station is smaller than a second predetermined threshold. If a determination result is positive, the third base station may transmit the occupation signal, and otherwise, the third base station may not transmit the occupation signal.

It should be noted that the occupation signal may satisfy a certain rule. In an exemplary embodiment, a proportion of the occupation signal to a transmission bandwidth may be greater than a predetermined proportion. In an exemplary embodiment, the proportion of the occupation signal to the transmission bandwidth may be enabled to be greater than the predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources. The proportion may be flexibly set as, for example, 80%.

In an exemplary embodiment, at least one of a CCA pattern, an eCCA pattern, a pattern of the occupation signal and a data transmission pattern may be indicated by pre-scheduling information. That is, pre-scheduling information may carry at least one of a CCA pattern, an eCCA pattern, a pattern of the occupation signal and a data transmission pattern.

FIG. 11 illustrates a second implementation of an occupation signal transmission device according to an embodiment of the present disclosure. The device may be applied to a first group of base stations and/or a second group of base stations. As shown in FIG. 11, the device may include a third transmission module 112. The device will be illustrated hereinbelow.

The third transmission module 112 may be configured to transmit an occupation signal by using at least one of the following manners. When detecting, on respective CCA and/or eCCA resources, that a channel is clear, the first group of base stations and/or the second group of base stations may transmit an occupation signal on the respective CCA and/or eCCA resources respectively. When detecting, on respective CCA and/or eCCA resources, that a channel is clear, the first group of base stations and/or the second group of base stations may transmit an occupation signal on an entire unlicensed carrier bandwidth respectively. When performing CCA and/or eCCA detection on entire unlicensed carrier bandwidth resources respectively and detecting that a channel is clear, the first group of base stations and/or the second group of base stations may respectively transmit an occupation signal on the entire unlicensed carrier bandwidth resources. When performing CCA and/or eCCA detection on entire unlicensed carrier bandwidth resources respectively and detecting that a channel is clear, the first group of base stations and/or the second group of base stations may transmit an occupation signal in respectively-negotiated resources. In the embodiment, each group of the first group of base stations and/or the second group of base stations may include two or more base stations.

In an exemplary embodiment, the occupation signal transmitted by the first group of base stations and/or the second group of base stations may carry at least one of a group identifier, a cell identifier and an operator identifier. In an exemplary embodiment, the occupation signal transmitted by the first group of base stations and/or the second group of base stations may be in at least one of the following forms: an SRS, a preamble, a PSS/SSS, and a predetermined identifier.

Herein, the device may further include a relevant checking module. The relevant checking module may be configured to: respectively perform, before the first group of base stations and/or the second group of base stations transmit the occupation signal, CCA and/or eCCA detection on CCA and/or eCCA resources respectively negotiated for the first group of base stations and/or the second group of base stations; and/or, respectively perform CCA and/or eCCA detection on entire unlicensed carrier bandwidth resources.

It can thus be seen that each group of base stations may include multiple base stations. In some exemplary embodiments, the base stations in the same group may have a certain characteristic. In an exemplary embodiment, base stations in the first group of base stations may have at least one of the following characteristics: base stations subordinate to a same operator; and base stations subordinate to different operators. In an exemplary embodiment, base stations in the second group of base stations may have at least one of the following characteristics: base stations subordinate to a same operator; and base stations subordinate to different operators. Herein, after a certain base station in one group obtains, through contention, some unlicensed carrier resources pre-configured or entire unlicensed carrier resources, other base stations in this group may transmit data by using the secured unlicensed carrier resources pre-configured or the entire unlicensed carrier resources. That is to say, a group of base stations may reuse the unlicensed carrier resources together.

In an exemplary embodiment, the device may further include a relevant data transmission module. The relevant data transmission module may be configured to transmit, after the first group of base stations and/or the second group of base stations transmit the occupation signal, data based on configured CCA and/or eCCA resources.

In an exemplary embodiment, the first group of base stations and/or the second group of base stations may transmit the occupation signal on entire unlicensed carrier bandwidth resources in one of the following manners. After the first group of base stations and/or the second group of base stations detect that a channel is clear, the first group of base stations and/or the second group of base stations may transmit an occupation signal on the entire unlicensed carrier bandwidth resources. After detecting that a channel is clear, the first group of base stations may transmit an occupation signal on the entire unlicensed carrier bandwidth resources, and when detecting that the channel is not clear, the second group of base stations may receive and parse the occupation signal transmitted by the first group of base stations.

Herein, before the first group of base stations and/or the second group of base stations transmit the occupation signal on entire unlicensed carrier bandwidth resources, the solution may further include at least one of the following acts. A first base station in the first group of base stations may determine that the first base station and a second base station which occupies the entire unlicensed carrier bandwidth resources in advance pertain to base stations subordinate to a same operator. A third base station in the second group of base stations may determine that the third base station and a fourth base station which occupies the entire unlicensed carrier bandwidth resources in advance pertain to base stations subordinate to a same operator. In some exemplary embodiment, base stations in different groups may pertain to the same operator.

Herein, when the first base station determines that the first base station and the second base station pertain to base stations subordinate to the same operator, the first base station may determine whether a distance between the first base station and the second base station is greater than a first predetermined threshold and/or may determine whether a signal intensity, received by the first base station, from the second base station is smaller than a second predetermined threshold. If a determination result is positive, the first base station may transmit the occupation signal, and otherwise, the first base station may not transmit the occupation signal. Alternatively or additionally, when the third base station determines that the third base station and the fourth base station pertain to base stations subordinate to the same operator, the third base station may determine whether a distance between the third base station and the fourth base station is greater than a first predetermined threshold and/or may determine whether a signal intensity, received by the third base station, from the fourth base station is smaller than a second predetermined threshold. If a determination result is positive, the third base station may transmit the occupation signal, and otherwise, the third base station may not transmit the occupation signal.

It should be noted that the occupation signal may satisfy a certain rule. In an exemplary embodiment, a proportion of the occupation signal to a transmission bandwidth may be greater than a predetermined proportion. In an exemplary embodiment, the proportion of the occupation signal to the transmission bandwidth may be enabled to be greater than the predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources. The proportion may be flexibly set as, for example, 80%.

In an exemplary embodiment, at least one of a CCA pattern, an eCCA pattern, a pattern of the occupation signal and a data transmission pattern may be indicated by pre-scheduling information. That is, pre-scheduling information may carry at least one of a CCA pattern, an eCCA pattern, a pattern of the occupation signal and a data transmission pattern.

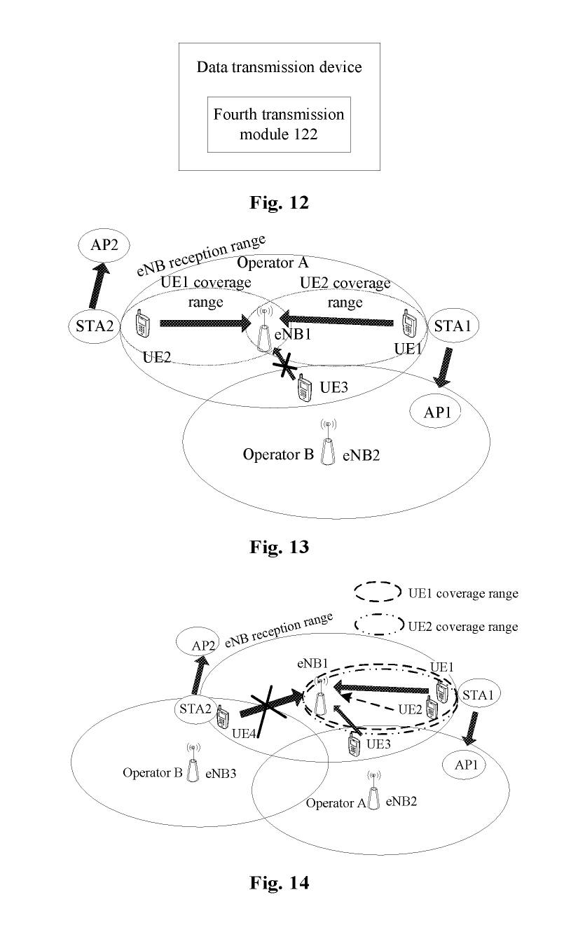

FIG. 12 is a block diagram of a fourth implementation of a data transmission device according to an embodiment of the present disclosure. The device may be applied to a first group of base stations and/or a second group of base stations. As shown in FIG. 12, the device may include a fourth transmission module 122. The device will be illustrated hereinbelow.

The fourth transmission module 122 may be configured to transmit data by using at least one of the following manners. The first group of base stations and/or the second group of base stations may transmit data in frequency domain resources identical to CCA and/or eCCA resources negotiated in advance for the first group of base stations and/or the second group of base stations. The first group of base stations and/or the second group of base stations may transmit data on entire unlicensed carrier bandwidth resources based on an advance resource negotiation result. In the embodiment, each group of the first group of base stations and/or the second group of base stations may include two or more base stations.

It can thus be seen that each group of base stations may include multiple base stations. In some exemplary embodiments, the base stations in the same group may have a certain characteristic. In an exemplary embodiment, base stations in the first group of base stations may have at least one of the following characteristics: base stations subordinate to a same operator; and base stations subordinate to different operators. In an exemplary embodiment, base stations in the second group of base stations may have at least one of the following characteristics: base stations subordinate to a same operator; and base stations subordinate to different operators. Herein, after a certain base station in one group obtains, through contention, some unlicensed carrier resources pre-configured or entire unlicensed carrier resources, other base stations in this group may transmit data by using the secured unlicensed carrier resources pre-configured or the entire unlicensed carrier resources. That is to say, a group of base stations may reuse the unlicensed carrier resources together.

In an exemplary embodiment, the device may further include a relevant detection module and transmission module. The relevant detection module and transmission module may be configured to: perform, before the first group of base stations and/or the second group of base stations transmit data, CCA and/or eCCA detection; and transmit, after the first group of base stations and/or the second group of base stations detect that a channel is clear, an occupation signal.

Herein, the relevant detection module may be configured to: enable the first group of base stations and/or the second group of base stations to respectively perform CCA and/or eCCA detection on the CCA and/or eCCA resources negotiated in advance for the first group of base stations and/or the second group of base stations; or enable the first group of base stations and/or the second group of base stations to perform CCA and/or eCCA detection on the entire unlicensed carrier bandwidth resources.

There may be multiple manners for transmission of the occupation signal. In an exemplary embodiment, the first group of base stations and/or the second group of base stations may transmit the occupation signal in one of the following manners. The first group of base stations and/or the second group of base stations may transmit an occupation signal on the CCA and/or eCCA resources negotiated in advance. The first group of base stations and/or the second group of base stations may transmit an occupation signal on the entire unlicensed carrier bandwidth resources.

Herein, the occupation signal transmitted by the first group of base stations and/or the second group of base stations may carry at least one of a group identifier, a cell identifier and an operator identifier. In an exemplary embodiment, the occupation signal transmitted by the first group of base stations and/or the second group of base stations may be in at least one of the following forms: an SRS, a preamble, a PSS/SSS, and a predetermined identifier.

In an exemplary embodiment, the device may further include a relevant determination module. The relevant determination module may be configured to: determine, before the first group of base stations and/or the second group of base stations transmit the occupation signal on the entire unlicensed carrier bandwidth resources, that a first base station and a second base station which occupies the entire unlicensed carrier bandwidth resources in advance pertain to base stations subordinate to a same operator; and/or, enable a third base station in the second group of base stations to determine that the third base station and a fourth base station which occupies the entire unlicensed carrier bandwidth resources in advance pertain to base stations subordinate to a same operator. In some exemplary embodiment, base stations in different groups may pertain to the same operator.

Herein, when the first base station determines that the first base station and the second base station pertain to base stations subordinate to the same operator, the first base station may determine whether a distance between the first base station and the second base station is greater than a first predetermined threshold and/or may determine whether a signal intensity, received by the first base station, from the second base station is smaller than a second predetermined threshold. If a determination result is positive, the first base station may transmit the occupation signal, and otherwise, the first base station may not transmit the occupation signal. Alternatively or additionally, when the third base station determines that the third base station and the fourth base station pertain to base stations subordinate to the same operator, the third base station may determine whether a distance between the third base station and the fourth base station is greater than a first predetermined threshold and/or may determine whether a signal intensity, received by the third base station, from the fourth base station is smaller than a second predetermined threshold. If a determination result is positive, the third base station may transmit the occupation signal, and otherwise, the third base station may not transmit the occupation signal.

It should be noted that the occupation signal may satisfy a certain rule. In an exemplary embodiment, a proportion of the occupation signal to a transmission bandwidth may be greater than a predetermined proportion. In an exemplary embodiment, the proportion of the occupation signal to the transmission bandwidth may be enabled to be greater than the predetermined proportion by means of at least one of the following manners: repeating the occupation signal; scrambling the occupation signal by using at least one of a group identifier, a cell identifier, an operator identifier and other predetermined identifiers; modifying a value of a subcarrier interval configured for a frequency domain; and transmitting the occupation signal at two ends of bandwidth frequency domain resources. The proportion may be flexibly set as, for example, 80%.

In an exemplary embodiment, at least one of a CCA pattern, an eCCA pattern, a pattern of the occupation signal and a data transmission pattern may be indicated by pre-scheduling information. That is, pre-scheduling information may carry at least one of a CCA pattern, an eCCA pattern, a pattern of the occupation signal and a data transmission pattern.

Hereinbelow, how a terminal or a base station in a group identifies an occupation signal transmitted on secured unlicensed carrier resources and avoids surrounding interference, so as to determine other terminals or base stations that can reuse the secured unlicensed carrier resources, is illustrated with reference to specific embodiments.

By taking a first group of terminals and a second group of terminals as an example, the specific embodiments of the present disclosure will be illustrated hereinbelow. It may be appreciated that the following embodiments are also suitable for groups of base stations likewise.

In the present embodiment, the following aspects are involved. One or more UEs (e.g., one or more UEs in the first group of terminals or one or more UEs in the second group of terminals) having a contention capacity may perform CCA and/or eCCA over a specific unlicensed carrier and transmit the occupation signal. A special functional part of the occupation signal, and a transmission rule for the occupation signal may meet a control requirement that the occupation signal occupies e.g., 80% or above of a transmission bandwidth.

The act performed after the UE performs CCA and/or eCCA on specific unlicensed carrier resources (the ‘specific’ unlicensed carrier resources may be entire unlicensed carrier resources or may be a part of unlicensed carrier resources pre-configured, there may be multiple configuration manners such as frequency division in a frequency domain) may include the acts as follows.

After a UE detects that an unlicensed carrier is clear by performing CCA and/or eCCA, the UE may transmit the occupation signal.

When a UE performs CCA and/or eCCA to detect that an unlicensed carrier channel is not clear (i.e., busy), and detects that an occupation signal over an unlicensed carrier is transmitted by another UE in the same group as the UE (for example, the two UEs may be UEs in the same cell or different cells subordinate to the same operator and are closer to each other), the UE may not transmit the occupation signal. In an exemplary embodiment, the UE may transmit the occupation signal.

When a UE performs CCA and/or eCCA to detect that an unlicensed carrier channel is not clear, and detects that an occupation signal over an unlicensed carrier is transmitted by another UE in the same group and the two UEs are distant from each other, the UE may need to transmit the occupation signal in order to shield surrounding hidden nodes.

When a UE performs CCA and/or eCCA to detect that an unlicensed carrier channel is not clear and detects that an occupation signal over an unlicensed carrier is transmitted by a UE in another group, the UE may stop performing CCA and/or eCCA, and may not transmit the occupation signal.

When a UE performs CCA and/or eCCA to detect that an unlicensed carrier channel is not clear, but the UE cannot detect whether a UE which occupies the unlicensed carrier in advance is in the same group as the UE, the UE may continue performing CCA and/or eCCA.

The occupation signal transmitted by the UE may be suggested to have the following characteristics:

Characteristic 1: UEs which are distant from each other and detect that a channel is clear during CCA and/or eCCA may need to independently transmit an occupation signal.

Characteristic 2: UEs which detect that a channel is clear during CCA and/or eCCA in the same group are not mutually exclusive.

Characteristic 1 may be mainly used to avoid a problem about hidden nodes at a UE side. According to the characteristic 1, UEs succeeding in contention are suggested to transmit an occupation signal under a condition that the UEs are distant from each other, so as to eliminate interference caused by the hidden nodes.

According to the characteristic 2, a UE in one group may identify that this occupation signal is transmitted by another UE in the same group through a certain manner, and therefore may omit the transmitted occupation signal and regard that the channel is clear, and may transmit its own occupation signal.

The following method may be adopted for enabling other UEs in the present group to identify an occupation signal transmitted by a UE succeeding in contention.

A signal detection method may be adopted. In the signal detection method, a UE which detects that a channel is clear by performing CCA and/or eCCA may include a group identifier, for example, a group ID, a cell ID or an operator identifier, in a transmitted occupation signal. As an exemplary implementation, position information of transmission resources may also be included in the transmitted occupation signal. Another UE which continues performing CCA and/or eCCA may detect that the occupation signal carries a group identifier identical to its own group identifier, so the UE may regard that this unlicensed carrier is clear and then may transmit its own occupation signal. If the UE detects that the occupation signal carries a group identifier not identical to its own group identifier, the UE may regard that the channel is not clear, and may stop detecting the channel.

In the method, whether the occupation signal is transmitted by the UE in the present group may be determined through detection based on the group identifier carried in the transmitted occupation signal. Here, the transmitted occupation signal may be in at least one of the following forms: an SRS, a preamble, a PSS/SSS, and a simple identifier.

Herein, the UE which detects that the channel is clear by performing CCA and/or eCCA may transmit an occupation signal having UE-specific functions. The specific functions of the occupation signal transmitted by the UE may include a channel occupation function and a measurement function.

The occupation signal transmitted at the UE side may be mainly used to occupy the channel. A UE which detects that the channel is clear by performing CCA and/or eCCA may immediately transmit an occupation signal over an unlicensed carrier after CCA and/or eCCA detection is successful. This signal may be a meaningless signal, a signal carrying a simple occupation identifier, a signal carrying a cell ID, a signal carrying an operator identifier, a signal carrying a UE ID and a cell ID, or a combination of these signals. Under this function, the transmitted occupation signal should first and foremost be able to preferentially occupy the channel, and preferably may carry an identifier enabling another UE which continues performing CCA and/or eCCA to identify whether the occupation signal is transmitted by the UE in the present group, so as to facilitate multi-user reuse transmission.

Herein, an occupation signal transmitted by UEs in different groups may at least carry a group identifier or a cell ID or an operator identifier. If the other UE which continues performing CCA and/or eCCA detects that the occupation signal is transmitted by a UE in a different group, detection may be immediately stopped, and it may be regarded that the channel has already been occupied.

The occupation signal transmitted by the UE side may be mainly used for measurement. The measurement function mainly refers to that a UE having a contention capacity makes a measurement judgment on a signal intensity received from the surrounding during CCA and/or eCCA detection. When performing surrounding signal intensity judgment, the UE which performs CCA and/or eCCA detection to find out that a channel is clear may regard that the surrounding signal intensity does not reach a preset interference threshold value, so it may be regarded that the channel is a nearly clear channel, and therefore an occupation signal may be transmitted. Another UE which continues performing CCA and/or eCCA detection may continue evaluating the value of the signal intensity from other surrounding UEs to accordingly judge whether the channel is clear. If the signal intensity, detected by the other UE which performs CCA and/or eCCA detection, of the UE which has transmitted the occupation signal does not reach a preset interference threshold value, the UE which performs CCA and/or eCCA detection may regard that the channel is clear, and may transmit an occupation signal. A distance (the distance may be calculated based on a formula P_{R}=P_{T}/rⁿ) between a surrounding UE which is transmitting an occupation signal and a UE which is measuring surrounding interference may be obtained based on the received signal intensity of the transmitted occupation signal, and the distance information may be subsequently used for other applications.

The transmitted occupation signal may be suggested to meet a control requirement that a ratio of the transmitted signal to a transmission bandwidth over an unlicensed carrier is e.g., 80% (or other ratios). The control requirement may be met by using at least one of the following rules.

Rule 1: An occupation signal may be simply repeated in a frequency domain.

Rule 2: Occupation signals specified in advance may be sequentially transmitted in a frequency domain in an ascending order, and an occupation signal sequence scrambled based on a group identifier, a UE ID, a cell ID and/or an operator identifier may be transmitted on remaining frequency domain resources.

Rule 3: The value of a subcarrier interval in a frequency domain may be modified. For example, the subcarrier interval may be 1.25 kHz, 2.5 kHz, 3.75 kHz, 5 kHz, 7.5 kHz, 10 kHz, 15 kHz, 20 kHz, 30 kHz, 60 kHz, 120 kHz and the like.

Rule 4: An occupation signal may be transmitted at two ends of bandwidth frequency domain resources. A specified sequence may not be transmitted on frequency domain resources between the two ends, or the frequency domain resources between the two ends may be spare for transmitting data or other information or transmitting nothing.

In a related technology, when a UE in an LTE system performs CCA on a specific unlicensed carrier to detect that a channel is clear, the UE may transmit an occupation signal, however, other UEs in the present group may perform detection only without performing any corresponding operation. As a result, nodes in other systems may mistakenly regard that the channel is clear and therefore may perform transmission on the channel, thereby cause a problem of serious interference. By virtue of the solution provided in the embodiments, this problem may be effectively solved. The method provided in some embodiments of present disclosure may properly address a problem about hidden nodes nearby a UE having a contention capacity, and may assist in measuring surrounding interference situations of the nodes. By virtue of this solution, not only it can be ensured that specific unlicensed carrier resources may be truly occupied, but also the surrounding interference situations of the nodes and the distances between the nodes may be obtained, thereby improving the utilization rate of unlicensed carrier resources. Furthermore, multiple methods enabling a ratio of a transmitted signal to a transmission bandwidth to be more than e.g., 80% are provided, and new significance may be endowed.

The present disclosure will be illustrated hereinbelow with reference to specific embodiments.

### First Embodiment

FIG. 13 is a diagram of solving a hidden node in an inter-system coexistence scenario according to a first embodiment of the present disclosure.

For a coexistence scenario of an LTE system and a Wi-Fi system on an unlicensed carrier, FIG. 13 shows a situation where two UEs having a contention capacity within a base station (e.g., an evolved NodeB, eNB) coverage range are distant from each other. As shown in FIG. 13, Station (STA) and Access Point (AP) nodes in the Wi-Fi system are close to the two UEs. The UEs may perform CCA and/or eCCA on specific unlicensed carrier resources.

After a UE detects that an unlicensed carrier is clear by performing CCA and/or eCCA, the UE may transmit an occupation signal.

When a UE performs CCA and/or eCCA to detect that an unlicensed carrier channel is not clear, and detects that an occupation signal over an unlicensed carrier is transmitted by another UE in the same group and the two UEs are distant from each other, the UE may need to transmit the occupation signal in order to shield surrounding hidden nodes.

When a UE performs CCA and/or eCCA to detect that an unlicensed carrier channel is not clear and detects that an occupation signal over an unlicensed carrier is transmitted by a UE in another group, the UE may stop performing CCA and/or eCCA, and may not transmit the occupation signal.

When a UE performs CCA and/or eCCA to detect that an unlicensed carrier channel is not clear, but the UE cannot detect a group identifier, the UE may continue performing CCA and/or eCCA.

Specific to the present embodiment, UE1, UE2 and UE3 are all UEs having a contention capacity, UE1 and UE2 are UEs in the same group, and UE3 is a UE in a group different from the group of UE1 and UE2. When UE1, UE2 and UE3 perform CCA and/or eCCA detection on a specific unlicensed carrier, only UE1 succeeds in execution of CCA and/or eCCA to detect that a channel is clear, then UE1 may immediately transmit an occupation signal carrying a group identifier.

When UE2 continues performing CCA and/or eCCA to detect that the channel is not clear, and detects that the occupation signal is transmitted by UE1 in the same group (a distance between UE1 and UE2 is relatively long), UE2 may transmit an occupation signal in order to shield a surrounding hidden node, e.g., STA2.

When UE3 continues performing CCA and/or eCCA to detect that the channel is not clear, and detects that a group identifier carried in the occupation signal is not consistent with the group identifier of its own group (i.e., group of UE3), UE3 may regard that the signal is not clear, therefore, UE3 may stop detection and may not transmit an occupation signal over a specific unlicensed carrier.

If UE2 and UE3 continue performing CCA and/or eCCA to detect that the channel is not clear, but UE2 and UE3 cannot detect a group identifier, UE2 and UE3 may continue performing CCA and/or eCCA.

The above embodiment may effectively address a problem about surrounding hidden nodes of a UE which successfully performs CCA and/or eCCA and obtains, through contention, a specific unlicensed carrier.

### Second Embodiment

FIG. 14 is a diagram of solving a hidden node in an inter-system coexistence scenario according to a second embodiment of the present disclosure.

In a coexistence scenario of LTE and Wi-Fi given in the present embodiment, FIG. 14 shows a situation where two UEs having a contention capacity within an eNB coverage range are close each other. As shown in FIG. 14, eNB1 and eNB2 are subordinate to the same operator, eNB2 has a subordinate UE, but eNB3 is a base station subordinate to an operator different from the operator of eNB1 and eNB2. A UE is located at a coverage overlapped part of eNB3 and eNB1. STA and AP nodes in a Wi-Fi system are close to these UEs.

After a UE detects that an unlicensed carrier is clear by performing CCA and/or eCCA on specific unlicensed carrier resources, the UE may transmit an occupation signal.

When a UE performs CCA and/or eCCA to detect that an unlicensed carrier channel is not clear, and detects that an occupation signal over an unlicensed carrier is transmitted by another UE in the same group (for example, the two UEs are close to each other, that is, the coverage ranges of the two UEs are nearly overlapped), the UE may not transmit an occupation signal.

Specific to the present embodiment, UE1, UE2, UE3 and UE4 are all UEs having a contention capacity, UE1, UE2 and UE3 are UEs in the same group, UE1 and UE2 are two UEs close to each other, and UE4 is a UE in another group. When UE1, UE2, UE3 and UE4 perform CCA and/or eCCA detection on a specific unlicensed carrier, only UE1 succeeds in execution of CCA and/or eCCA, and when detecting that a channel is clear, UE1 may immediately transmit an occupation signal carrying a group identifier.

When UE2 continues performing CCA and/or eCCA to detect that the channel is not clear, and detects that the occupation signal is transmitted by UE1 in the same group (a distance between UE1 and UE2 is relatively short), UE2 may not transmit an occupation signal since UE1 close to UE2 has transmitted the occupation signal to shield a surrounding hidden node.

When UE3 continues performing CCA and/or eCCA to detect that the channel is not clear, and detects that a group identifier carried in the occupation signal is identical to its own group identifier, UE3 may regard that the signal is clear, and may transmit an occupation signal.

When UE4 continues performing CCA and/or eCCA to detect that the channel is not clear, and detects that a group identifier carried in the occupation signal is different from its own group identifier, UE4 may regard that the signal is not clear, so UE4 may stop detection, and may not transmit an occupation signal over a specific unlicensed carrier.

If UE2, UE3 and UE4 continue performing CCA and/or eCCA to detect that the channel is not clear, but UE2, UE3 and UE4 cannot detect a group identifier, then UE2, UE3 and UE4 may continue performing CCA and/or eCCA.

### Third Embodiment

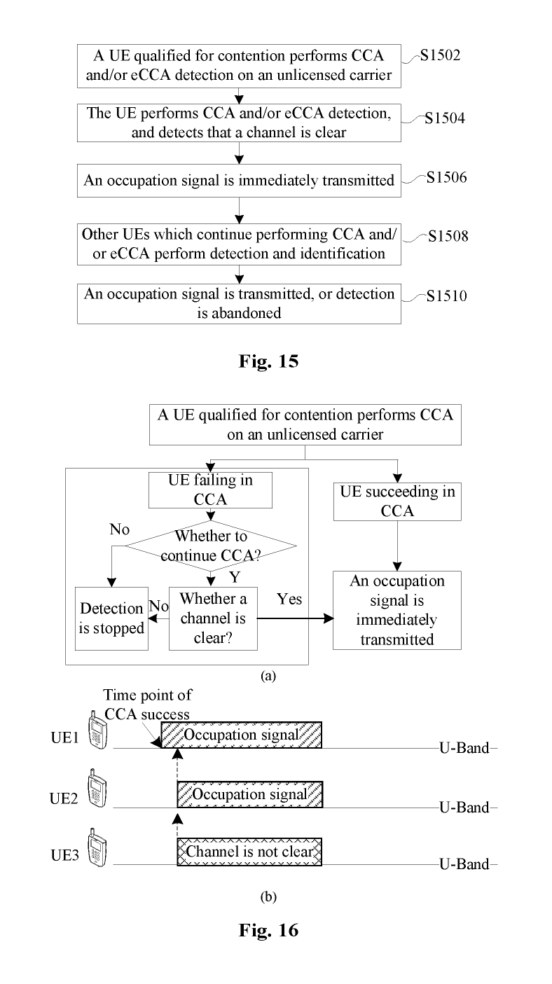

FIG. 15 is an overall flowchart showing execution of CCA and/or eCCA and identification of an occupation signal through a UE according to a third embodiment of the present disclosure.

FIG. 15 shows an overall flow about how a UE qualified for contending an unlicensed carrier at a UE side performs CCA and/or eCCA on a specific unlicensed carrier and may transmit an occupation signal to occupy a channel. The flow may include the acts S1502 to S1510 as follows.

At act S1502, all UEs qualified for contention may perform CCA and/or eCCA on an unlicensed carrier specified for contention. The specified unlicensed carrier may be an unlicensed carrier at a predetermined position (such as an odd position or an even position), or may be the entire unlicensed carrier.

In the present act, the UEs qualified for contention may include: a UE having received a UL grant, a UE needing to transmit data, a UE in a group specified by a base station, and the like. These UEs qualified for contention may perform CCA and/or eCCA on an unlicensed carrier specified in advance by the base station.

For CCA and/or eCCA detection performed by the UEs, it may be assumed that each UE performs CCA and/or eCCA at identical or different starting time, and adopts different manners of calculating surrounding interference. Here, CCA and/or eCCA detection and signal identification may be implemented based on signal detection and interference calculation methods.

At act S1504, a UE may perform CCA and/or eCCA to detect that a channel is clear.

At act S1506, the UE may immediately transmit an occupation signal over an unlicensed carrier thereof.

In the above act, a UE which successfully performs CCA and/or eCCA may immediately transmit an occupation signal over a secured unlicensed carrier. Here, the transmitted occupation signal may carry a group identifier such as a group ID, a cell ID or an operator identifier, and may be used for subsequent channel detection and signal parsing of other UEs.

At act S1508, other UEs which continue performing CCA and/or eCCA may perform detection and identification.

At act S1510, an occupation signal may be transmitted or detection may be abandoned based on detection and identification results. The UE which continues performing CCA and/or eCCA at the UE side may find out that the specific unlicensed carrier is occupied, and may detect information in the signal. If it is detected that a group identifier carried in the occupation signal is identical to that of the group of this UE, it may be regarded that the channel is clear. Based on the situation in the first embodiment, if a distance between a UE which performs detection currently and the UE which has transmitted the occupation signal is long, the UE may transmit an occupation signal to avoid surrounding hidden nodes of the UE. Based on the situation in the second embodiment, the UE may not transmit an occupation signal, and may regard that the surrounding hidden nodes have been shielded. If detecting that the group identifier carried in the occupation signal is identical to that of the group of the current UE, the UE may regard that the channel is clear, and may transmit an occupation signal. If detecting that the group identifier carried in the occupation signal is different from that of the group of the current UE, the UE may regard that the channel has been occupied, and may stop performing CCA and/or eCCA detection.

### Fourth Embodiment

FIG. 16 is a diagram illustrating a process for a UE which does not succeed in contention according to a fourth embodiment of the present disclosure.

As shown in FIG. 16 (a), some or only one of UEs qualified for contention may successfully occupy an unlicensed carrier, and other UEs failing in the contention may process based on the following methods.

First method: A UE which fails in CCA and/or eCCA may not continue performing CCA and/or eCCA, and may regard that the channel has been occupied, and therefore may stop performing energy detection on the channel.

Second method: A UE which fails in CCA and/or eCCA may continue performing CCA and/or eCCA to detect whether a channel is clear. Here, the act of continuing detecting whether a channel is clear may refer to: detecting and identifying whether an occupation signal is transmitted by another UE in the same group. A UE which detects that the channel is clear and fails in contention may immediately transmit an occupation signal. The situation where the UE which fails in CCA and/or eCCA continues performing CCA and/or eCCA will be elaborated hereinbelow.

Specific to the present embodiment, as shown in FIG. 16 (b), it is assumed that UE1, UE2 and UE3 are UEs in the same group. If UE1 successfully obtains, through contention, an unlicensed carrier during execution of CCA and/or eCCA, UE1 may immediately transmit an occupation signal. UE2 and UE3 may detect the occupation signal on the channel, and may parse information about the occupation signal. If a group identifier such as a group ID carried in the occupation signal transmitted by UE1 is identical to those carried in UE2 and UE3, UE2 and UE3 may regard that the channel is clear, and may immediately transmit an occupation signal. If other UEs such as UE4 or UE5 perform CCA and/or eCCA, the abovementioned method may be adopted.

It is assumed that UE1, UE2 and UE3 are UEs in the same group. If UE1 successfully obtains, through contention, an unlicensed carrier during execution of CCA and/or eCCA, UE1 may immediately transmit an occupation signal. UE2 and UE3 may continue performing CCA and/or eCCA to detect a channel situation. If detecting an occupation signal on the channel, UE2 and UE3 may parse a group identifier such as a group ID, a cell ID and/or an operator identifier carried in the occupation signal. If UE2 and UE3 find out that the group identifier carried in the occupation signal is identical to their own group identifier, UE2 and UE3 may regard that the channel is clear, and may immediately transmit an occupation signal (when a distance between UE1 and UE2/UE3 is short, the occupation signal may not be transmitted). If UE2 and UE3 find out that the group identifier carried in the occupation signal is different from their own group identifier, UE2 and UE3 may regard that the channel is not clear, and therefore may stop detecting the unlicensed carrier.

During the CCA and/or eCCA process of the UE which fails in contention, it may be judged whether a relative distance between UEs is greater than a first predetermined threshold or whether signal energy between UEs is smaller than a second predetermined threshold, so as to determine whether a UE which performs correct parsing needs to transmit an occupation signal. The signal energy may be signal energy of surrounding nodes.

### Fifth Embodiment

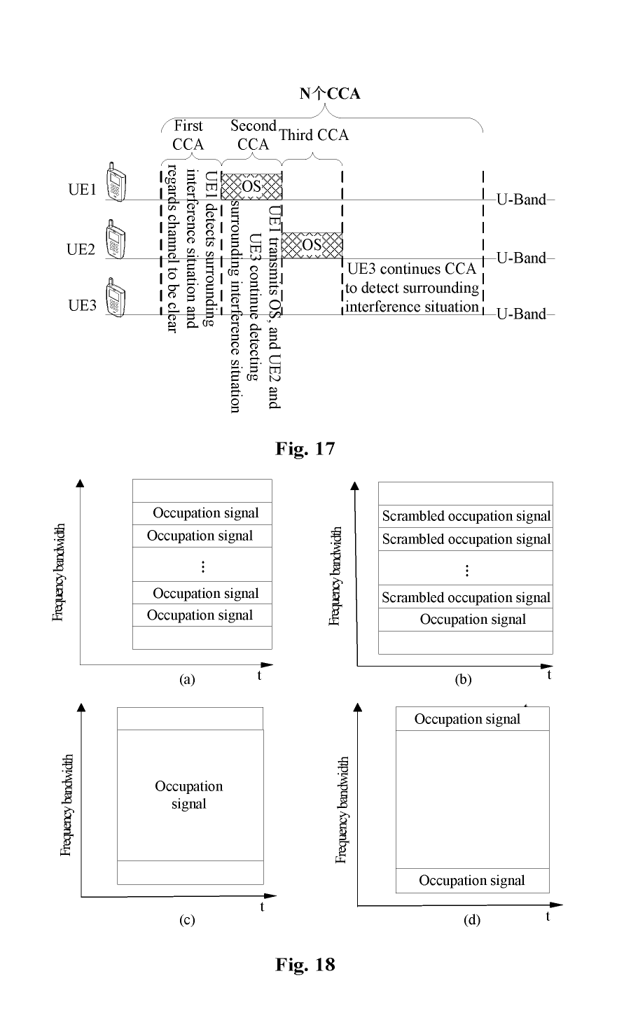

FIG. 17 is a diagram of transmission of an occupation signal for measurement function by a UE according to a fifth embodiment of the present disclosure.

The present embodiment mainly elaborates a situation that a UE which detects that a channel is clear by performing CCA and/or eCCA may transmit an occupation signal for a measurement function. When CCA and/or eCCA detection is started, it is assumed that no surrounding information transmission nodes exist, information transmitted by a distant node being ignored here.

As shown in FIG. 17, UE1, UE2 and UE3 may perform energy detection in a first CCA and/or eCCA period. Since no other surrounding nodes transmit information or other nodes are in a silent state, the three UEs may execute CCA on a specific unlicensed carrier. For example, only UE1 judges that a channel is clear at this time based on its own surrounding interference situation, and may transmit an occupation signal. When detecting a surrounding signal intensity situation, UE2 and UE3 may regard that the channel is not clear, and therefore may continue performing CCA and/or eCCA detection. In a next CCA and/or eCCA period, UE2 and UE3 which continue performing CCA and/or eCCA detection may judge the surrounding signal intensity situation again, and may parse the transmitted occupation signal. When finding out that UE1 is transmitting an occupation signal, the distance therebetween may be obtained based on a ratio of the transmission power of UE1 to the receiving power of UE2 and UE3 at this time. Whether the occupation signal is transmitted by a UE in the present group may be judged based on information (such as a group ID, a cell ID and/or an operator identifier) carried in the occupation signal, and it may be decided whether to transmit an occupation signal to shield surrounding hidden nodes. In a second CCA and/or eCCA period, for example, only UE2, which is a UE distant from UE1, correctly detects and parses that the occupation signal transmitted over the unlicensed carrier is transmitted by UE1 in the present group, then UE2 may need to transmit an occupation signal to shield surrounding hidden nodes. UE3 fails in detection and parsing, so UE3 may continue performing CCA and/or eCCA detection.

### Sixth Embodiment

FIG. 18 is a diagram of an occupation signal which meets a control requirement based on various rules according to a sixth embodiment of the present disclosure.

In order to meet a control requirement that a ratio of a signal transmitted over an unlicensed carrier to a transmission bandwidth should be more than e.g., 80%, as shown in FIG. 18, the control requirement may be met through the following rules.

Rule 1: An occupation signal may be simply repeated in a frequency domain.

Rule 2: Occupation signals specified in advance may be sequentially transmitted in a frequency domain in an ascending order, and an occupation signal sequence scrambled based on a group identifier, a UE ID, a cell ID, an operator identifier, a same-frequency multiplexing indication or a combination thereof may be transmitted on remaining frequency domain resources.

Rule 3: The value of a subcarrier interval in a frequency domain may be modified. For example, the subcarrier interval may be 1.25 kHz, 2.5 kHz, 3.75 kHz, 5 kHz, 7.5 kHz, 10 kHz, 15 kHz, 20 kHz, 30 kHz, 60 kHz, 120 kHz and the like.

Rule 4: An occupation signal may be transmitted at two ends of bandwidth frequency domain resources. A specified sequence may not be transmitted on frequency domain resources between the two ends, or the frequency domain resources between the two ends may be spare for transmitting data or other information or transmitting nothing.

Specific to the present embodiment, the transmitted occupation signal here may be a signal which does not carry any useful information or a signal or channel for a PSS/SSS, an SRS or a preamble. A preamble sequence is taken as an example. A preamble may occupy six RBs in a frequency domain, one RB has 12 subcarriers, and usually, a subcarrier interval is 15 kHz, under such a condition, the occupation signal cannot meet a requirement for occupying e.g., 80% of a channel bandwidth. In view of the above, the subcarrier interval may be modified to make the occupied bandwidth reach e.g., 80% of the transmission bandwidth, as shown in FIG. 18 (c). Based on the available value of the current subcarrier interval, namely 1.25 kHz, 2.5 kHz, 3.75 kHz, 5 kHz, 7.5 kHz, 10 kHz, 15 kHz, 20 kHz, 30 kHz, 60 kHz, 120 kHz and the like, the subcarrier interval may be changed flexibly based on a bandwidth requirement needed for transmitting an occupation signal.

Rule 1 is relatively simple. That is, an occupation signal may be transmitted over a symbol after CCA success, and if the occupation signal only occupies a part of resources in a frequency domain, the occupation signal may be simply repeated in the frequency domain based on Method 1, so the occupied bandwidth may reach e.g., 80% of the transmission bandwidth, as shown in FIG. 18 (a).

Rule 2 is a method of scrambling a transmission occupation sequence. For the situation where an original occupation signal to be transmitted does not meet a requirement for e.g., 80% occupation in the frequency domain, the requirement that the occupied bandwidth is e.g., 80% of the transmission bandwidth may be met by means of a method for transmitting an original sequence scrambled by a group identifier, a cell ID, an operator identifier or an identifier implying an indication, as shown in FIG. 18 (b).

Rule 4 refers to transmitting an occupation signal at two ends of a frequency domain resource to meet the requirement that the occupation signal occupies e.g., 80% of the bandwidth. Basically, if frequency domain resources occupied for transmitting an occupation signal at two ends of the total bandwidth frequency domain resource occupy 20% or below of the transmission bandwidth, it may be regarded that the channel occupation situation meets the requirement for e.g., 80% or above. Based on different combinations of blank and occupation signals in the frequency domain resources between the two ends of the total bandwidth frequency domain resource, different patterns may be generated. Specific to FIG. 18 (d), the occupation signal may be transmitted in a blank manner, or indication information, signaling or data may be transmitted over some REs for transmitting the occupation channel. Specifically, the occupation of the indication information and data may be determined as appropriate based on various rules, for example, each of the indication information and the data occupies half resources in a time domain, or each of the indication information and the data occupies half resources in a frequency domain, or the data fully occupy the entire occupation signal resource. Further, spare resources between the two ends of the total bandwidth frequency domain resources may be used to transmit Physical Uplink Shared Channel (PUSCH) resources or data. If Rule 4 is adopted, unlicensed carrier frequency domain resources may be better utilized.

### Seventh Embodiment

When a terminal side and/or a base station side perform CCA and/or eCCA detection for current LTE-U, clear channel detection may be performed on the basis of an entire frequency domain bandwidth. In such manner of performing CCA and/or eCCA detection on entire frequency domain resources, if a terminal or a base station detects that a channel is clear, data may be transmitted on entire secured unlicensed carrier resources, which may cause low reuse rate of resources.

The solution in the embodiment of the present disclosure mainly includes the following content. First, a concept of group may be introduced, and terminals or base stations may be divided into groups. Second, UEs in different groups or base stations in different groups may perform corresponding CCA and/or eCCA detection in different frequency domain resources in a frequency domain. If the UEs in different groups or the base stations in different groups detect that a channel is clear based on a CCA and/or eCCA detection result, the UEs or the base stations in the groups can reuse clear unlicensed carrier resources detected at the corresponding frequency domain positions. This solution not only enables UEs or base stations in different groups to avoid mutual interference during clear channel detection, but also enables the UEs or the base stations in the groups to reuse the secured resources (that is, resources obtained through contention) together, thereby reusing resources to a great extent. Detailed description will be made in the present embodiment hereinbelow.

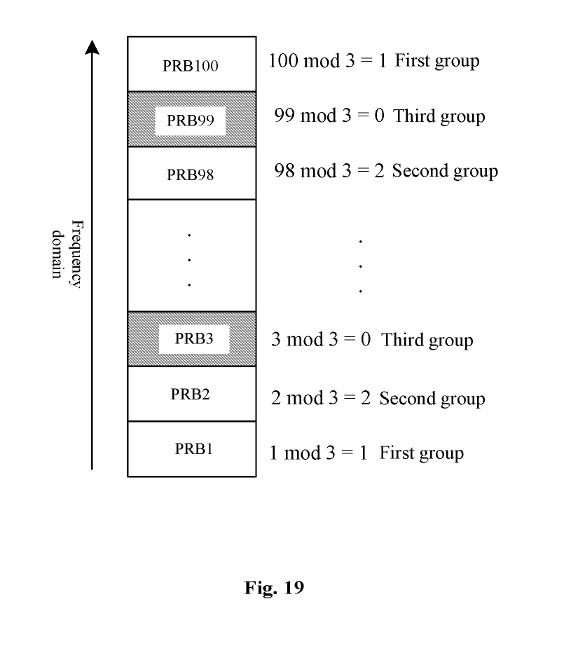

FIG. 19 is a diagram of CCA and/or eCCA resources or data resources according to an embodiment of the present disclosure.

The present embodiment mainly illustrates that a UE performs CCA and/or eCCA detection on a specific unlicensed carrier pre-configured for a group to which the UE pertains or a part of frequency domain resources, in a certain unlicensed carrier, pre-configured for the group to which the UE pertains, and may transmit an occupation signal.

A CCA and/or eCCA detection pattern, an occupation signal transmission pattern and a data transmission pattern are illustrated hereinbelow.

There may be two CCA and/or eCCA detection patterns, respectively adopting a manner of frequency division in a frequency domain or a manner of occupying entire unlicensed carrier resources. Specifically speaking, one is a CCA resource or eCCA resource pre-configured for this group of terminals, and the other one is a CCA resource or eCCA resource corresponding to the entire unlicensed carrier resources. The CCA resource or eCCA resource pre-configured may be a resource at a specific position, or may be a resource at an odd position or a resource at an even position. Moreover, the CCA resources or eCCA resources configured for each group may be different, and resources (the resources may be configured based on an odd or even number, or may be configured in a segmentation manner, or may be configured at equal intervals or unequal intervals) at different positions may be configured for different groups. Patterns for CCA and/or eCCA detection of different groups are illustrated with some examples. It is assumed that a bandwidth of an unlicensed spectrum system is 20 MHz (a 20 MHz system bandwidth is equal to 100 PRBs or equal to 1200 subcarriers in the frequency domain), and there are three different groups of UEs (namely a first group of UEs, a second group of UEs and a third group of UEs). By means of a rule, i.e., (PRB number in frequency domain) Mod (total number of UE groups), corresponding resources with the value of 0, 1, 2 obtained by the rule 100 PRBs Mod 3 in a frequency domain may be respectively allocated to the first group of UEs, the second group of UEs and the third group of UEs in sequence for CCA and/or eCCA detection.

There may also be two occupation signal transmission patterns, respectively adopting a manner of frequency division in a frequency domain or a manner of occupying entire unlicensed carrier resources. Specifically speaking, one is transmission of an occupation signal on resources pre-configured, and the other one is transmission of an occupation signal on an entire unlicensed carrier. Moreover, the resources pre-configured may be unlicensed carrier bandwidth resources at specific positions, or may be resources at odd positions or resources at even positions. The specific configuration manner is as described above.

There may also be two data transmission patterns, respectively adopting a manner of frequency division in a frequency domain or a manner of occupying entire unlicensed carrier resources. Specifically speaking, one is transmission of data on resources pre-configured, and the other one is transmission of data on an entire unlicensed carrier. Moreover, the resources pre-configured may be unlicensed carrier bandwidth resources at specific positions, or may be resources at odd positions or resources at even positions. The specific configuration manner is as described above.

Herein, there may be multiple configuration manners for the abovementioned patterns. As described above, for terminal groups, the patterns may be allocated by base stations, or may be negotiated between different terminal groups. For base station groups, the patterns may be determined by negotiation between different base station groups.

From the above, it may be concluded that there may be two CCA and/or eCCA detection patterns, two occupation signal transmission patterns and two data transmission patterns. Different types of patterns may be freely combined in eight combination manners, including: (1) performing CCA and/or eCCA detection on resources pre-configured, transmitting an occupation signal on resources pre-configured, and transmitting data on resources pre-configured; (2) performing CCA and/or eCCA detection on resources pre-configured, transmitting an occupation signal on resources pre-configured, and transmitting data on entire unlicensed carrier resources; (3) performing CCA and/or eCCA detection on resources pre-configured, transmitting an occupation signal on entire unlicensed carrier resources, and transmitting data on resources pre-configured; (4) performing CCA and/or eCCA detection on resources pre-configured, transmitting an occupation signal on entire unlicensed carrier resources, and transmitting data on entire unlicensed carrier resources; (5) performing CCA and/or eCCA detection on entire unlicensed carrier resources, transmitting an occupation signal on resources pre-configured, and transmitting data on resources pre-configured; (6) performing CCA and/or eCCA detection on entire unlicensed carrier resources, transmitting an occupation signal on resources pre-configured, and transmitting data on entire unlicensed carrier resources; (7) performing CCA and/or eCCA detection on entire unlicensed carrier resources, transmitting an occupation signal on entire unlicensed carrier resources, and transmitting data on resources pre-configured; and (8) performing CCA and/or eCCA detection on entire unlicensed carrier resources, transmitting an occupation signal on entire unlicensed carrier resources, and transmitting data on entire unlicensed carrier resources.

The present disclosure is illustrated hereinbelow for a problem regarding how to avoid interference among three groups of UEs. It is assumed that the group mentioned here is a UE group. As shown in FIG. 19, a base station side may inform the first group of UEs, the second group of UEs and the third group of UEs of frequency domain resource positions for performing CCA and/or eCCA detection in a frequency domain. That is, a Mod result of a PRB number and a total number of UE groups in the frequency domain being 0 represents that the third group of UEs perform CCA and/or eCCA detection on this PRB. Likewise, a Mod result being 1 represents that corresponding PRB resources are allocated to the first group of UEs. A Mod result being 2 represents that corresponding PRB resources are allocated to the second group of UEs.

Herein, the first group of UEs and/or the second group of UEs and/or the third group of UEs may be UEs in the same cell, or may be UEs in different cells subordinate to the same operator, or may be UEs in different cells subordinate to different operators.

The first group of UEs, the second group of UEs and the third group of UEs may perform CCA and/or eCCA detection on their respective resources. If the first group of UEs successfully perform CCA and/or eCCA detection (under an FBE, only one CCA needs to be performed, and if it is detected that a channel is clear, it may be regarded that CCA detection is successful; and under an LBE, a STA may perform eCCA detection until a random return value is zero, and if it is detected that a channel is clear, it may be regarded that CCA detection is successful) in resources allocated thereto, an occupation signal may be immediately transmitted. If the second group of UEs successfully perform CCA and/or eCCA detection in resources allocated thereto, an occupation signal may be transmitted on the corresponding resources likewise. Likewise, if the third group of UEs successfully perform CCA and/or eCCA detection in resources allocated to the third group of UEs, an occupation signal may be transmitted on the corresponding resources likewise. The three groups of UEs may respectively perform detection and occupation signal transmission on their respective resources through a frequency division manner, so mutual interference may be avoided.

Herein, UEs which detect whether a channel is clear on respectively-allocated resources and have transmitted occupation signal may reuse resources consistent with resource positions for performing CCA and/or eCCA detection from a first symbol position or a first subframe position after the occupation signal are transmitted, or may reuse resources configured during pre-scheduling. When different groups of UEs reuse resources consistent with resource positions for performing CCA and/or eCCA detection, resources reused by the UEs in the groups may be pre-scheduled by base stations or negotiated between the base stations or negotiated between the UEs in the groups.

Alternatively, the first group of UEs, the second group of UEs and the third group of UEs may perform CCA and/or eCCA detection on their respective resources. If the first group of UEs successfully perform CCA and/or eCCA detection in resources allocated to the first group of UEs, an occupation signal may be immediately transmitted in an entire bandwidth. If the second group of UEs successfully perform CCA and/or eCCA detection in resources allocated to the second group of UEs, an occupation signal may be transmitted on the corresponding resources in an entire bandwidth likewise. The third group of UEs may perform similar operation. When the first group of UEs or the second group of UEs or the third group of UEs unsuccessfully perform CCA and/or eCCA detection, the occupation signal in the entire bandwidth shall be received and parsed. If it is regarded that the resources can be reused after parsing, resources consistent with resource positions for performing CCA and/or eCCA detection may be reused or resources allocated during pre-scheduling may be reused from a first symbol position or a first subframe position after the occupation signal is transmitted.

Likewise, the first group, the second group and the third group of UEs in FIG. 19 may alternatively be groups of base stations. FIG. 19 shows pre-configured positions of the first group of base stations, the second group of base stations and the third group of base stations for a base station side. The three groups of base stations may perform CCA and/or eCCA detection at corresponding resource positions, and may immediately transmit an occupation signal if detecting that a channel is clear. The base stations, the same as the terminal side, may reuse resources consistent with resource positions for performing CCA and/or eCCA detection or may reuse negotiated resources.

Obviously, a person skilled in the art shall understand that all of the abovementioned modules or acts in the present disclosure may be implemented by using a general calculation device, may be centralized on a single calculation device or may be distributed on a network composed of a plurality of calculation devices. In an exemplary embodiment, they may be implemented by using executable program codes of the calculation devices. Thus, they may be stored in a storage device and executed by the calculation devices, the shown or described acts may be executed in a sequence different from this sequence under certain conditions, or they are manufactured into each integrated circuit module respectively, or multiple modules or acts therein are manufactured into a single integrated circuit module. Thus, the present disclosure is not limited to a combination of any specific hardware and software.

The above is only the preferable embodiments of the present disclosure, and not intended to limit the present disclosure. As will occur to a person skilled in the art, the present disclosure is susceptible to various modifications and changes. Any modifications, equivalent replacements, improvements and the like made within the principle of the present disclosure shall fall within the scope of protection defined by the appended claims of the present disclosure.

### INDUSTRIAL APPLICABILITY

As above, the data transmission method and device and the occupation signal transmission method and device, provided in some embodiments of the present disclosure, have the following beneficial effects. A group of terminals may be adopted to perform CCA and/or eCCA detection on unlicensed carrier bandwidth resources, and subsequently, a group of terminals may be used to transmit data over a clear unlicensed carrier. Compared with a solution of adopting a single terminal to perform CCA and/or eCCA detection for data transmission, the solution may effectively improve the reuse rate of resources, and may achieve an effect that multiple terminals may transmit data at the same time, thereby improving the efficiency of data exchange between a terminal and other nodes. Therefore, a problem of low reuse rate of resources may be solved, thereby achieving the effect of improving the reuse rate of resources.

1. A data transmission method, comprising:
performing, by a first group of terminals and/or a second group of terminals, Clear Channel Assessment (CCA) and/or evolved CCA (eCCA) detection on unlicensed carrier bandwidth resources by using at least one of the following manners: respectively performing, by the first group of terminals and/or the second group of terminals, CCA and/or eCCA detection on CCA and/or eCCA resources pre-configured for the first group of terminals and/or the second group of terminals; and respectively performing, by the first group of terminals and/or the second group of terminals, CCA and/or eCCA detection on entire unlicensed carrier bandwidth resources, wherein each group of the first group of terminals and/or the second group of terminals comprises one or more terminals; and
determining, by the first group of terminals and/or the second group of terminals, subsequent data transmission based on a detection result.

2. The method as claimed in claim 1, wherein
terminals in the first group of terminals have at least one of the following characteristics: terminals in a same cell; terminals in different cells subordinate to a same operator; and terminals in different cells subordinate to different operators;
terminals in the second group of terminals have at least one of the following characteristics: terminals in a same cell; terminals in different cells subordinate to a same operator; and terminals in different cells subordinate to different operators.

3. The method as claimed in claim 1, wherein the CCA and/or eCCA resources pre-configured for the first group of terminals and/or the second group of terminals are configured by using at least one of the following manners:
the CCA and/or eCCA resources are configured by a base station; and
the CCA and/or eCCA resources are configured via a negotiation between the first group of terminals and the second group of terminals.

4. The method as claimed in claim 1, further comprising one of the following case 1 and case 2:
case 1: after the first group of terminals and/or the second group of terminals respectively perform CCA and/or eCCA detection on the pre-configured CCA and/or eCCA resources, the method further comprises:
determining, by the first group of terminals and/or the second group of terminals, that a channel is clear;
respectively transmitting, by the first group of terminals and/or the second group of terminals, an occupation signal on unlicensed carrier bandwidth resources subjected to CCA and/or eCCA detection; or, respectively transmitting, by the first group of terminals and/or the second group of terminals, an occupation signal on the entire unlicensed carrier bandwidth resources; and
determining, by the first group of terminals and/or the second group of terminals, subsequent data transmission based on the transmitted occupation signal;
case 2: after the first group of terminals and/or the second group of terminals respectively perform CCA and/or eCCA detection on the entire unlicensed carrier bandwidth resources, the method further comprises:
determining, by the first group of terminals and/or the second group of terminals, that a channel is clear; and
after the first group of terminals and/or the second group of terminals detect that the channel is clear, respectively transmitting, by the first group of terminals and/or the second group of terminals, an occupation signal on the entire unlicensed carrier bandwidth resources; or, after the first group of terminals detect that the channel is clear, transmitting, by the first group of terminals, an occupation signal on the entire unlicensed carrier bandwidth resources, and when the second group of terminals detect that the channel is not clear, receiving and parsing, by the second group of terminals, the occupation signal transmitted by the first group of terminals.

5. (canceled)

6. The method as claimed in claim 4, wherein the occupation signal transmitted by the first group of terminals and/or the second group of terminals carries at least one of a group identifier, a cell identifier and an operator identifier, and the occupation signal transmitted by the first group of terminals and/or the second group of terminals is in at least one of the following forms:
a Sounding Reference Signal (SRS), a preamble, a Primary Synchronization Sequence/Secondary Synchronization Sequence (PSS/SSS), and a predetermined identifier.

7. The method as claimed in claim 4, wherein before the first group of terminals and/or the second group of terminals transmit the occupation signal on the entire unlicensed carrier bandwidth resources, the method further comprises:
determining, by a first terminal in the first group of terminals, that the first terminal and a second terminal which occupies the entire unlicensed carrier bandwidth resources in advance pertain to terminals in a same cell or different cells subordinate to a same operator; and/or,
determining, by a third terminal in the second group of terminals, that the third terminal and a fourth terminal which occupies the entire unlicensed carrier bandwidth resources in advance pertain to terminals in a same cell or different cells subordinate to a same operator.

8. The method as claimed in claim 7, wherein
when the first terminal determines that the first terminal and the second terminal pertain to terminals in the same cell or different cells subordinate to the same operator, determining, by the first terminal, whether a distance between the first terminal and the second terminal is greater than a first predetermined threshold and/or determining, by the first terminal, whether a signal intensity, received by the first terminal, from the second terminal is smaller than a second predetermined threshold, if a determination result is positive, transmitting, by the first terminal, the occupation signal, and otherwise, not transmitting, by the first terminal, the occupation signal; and/or,
when the third terminal determines that the third terminal and the fourth terminal pertain to terminals in the same cell or different cells subordinate to the same operator, determining, by the third terminal, whether a distance between the third terminal and the fourth terminal is greater than a first predetermined threshold and/or determining, by the third terminal, whether a signal intensity, received by the third terminal, from the fourth terminal is smaller than a second predetermined threshold, if a determination result is positive, transmitting, by the third terminal, the occupation signal, and otherwise, not transmitting, by the third terminal, the occupation signal.

9. The method as claimed in claim 4, wherein a proportion of the occupation signal to a transmission bandwidth is enabled to be greater than a predetermined proportion by means of at least one of the following manners:
repeating the occupation signal;
scrambling the occupation signal by using at least one of a group identifier, a cell identifier, an operator identifier and other predetermined identifiers;
modifying a value of a subcarrier interval configured for a frequency domain; and
transmitting the occupation signal at two ends of bandwidth frequency domain resources.

10. The method as claimed in claim 1, wherein at least one of a CCA pattern, an eCCA pattern and a data transmission pattern is indicated by pre-scheduling information.

11. The method as claimed in claim 10, wherein at least one of the CCA pattern, the eCCA pattern and the data transmission pattern is of a Physical Resource Block (PRB) level or a Resource Element (RE) level.

12. The method as claimed in claim 4, wherein a pattern of the occupation signal is indicated by pre-scheduling information.

13. The method as claimed in claim 12, wherein the pattern of the occupation signal is of a PRB level or an RE level.

14.-41. (canceled)

42. A data transmission method, comprising:
performing, by a first group of base stations and/or a second group of base stations, Clear Channel Assessment (CCA) and/or evolved CCA (eCCA) detection on unlicensed carrier bandwidth resources by using at least one of the following manners: respectively performing, by the first group of base stations and/or the second group of base stations, CCA and/or eCCA detection on CCA and/or eCCA resources respectively negotiated for the first group of base stations and/or the second group of base stations; or, respectively performing, by the first group of base stations and/or the second group of base stations, CCA and/or eCCA detection on entire unlicensed carrier bandwidth resources, wherein each group of the first group of base stations and/or the second group of base stations comprises one or more base stations; and
determining, by the first group of base stations and/or the second group of base stations, subsequent data transmission based on a detection result.

43. The method as claimed in claim 42, wherein
base stations in the first group of base stations have at least one of the following characteristics: base stations subordinate to a same operator; and base stations subordinate to different operators;
base stations in the second group of base stations have at least one of the following characteristics: base stations subordinate to a same operator; and base stations subordinate to different operators.

44. The method as claimed in claim 42, further comprising one of the following case 1 and case 2:
case 1: after the first group of base stations and/or the second group of base stations perform CCA and/or eCCA detection on CCA and/or eCCA resources respectively negotiated for the first group of base stations and/or the second group of base stations, the method further comprises:
determining, by the first group of base stations and/or the second group of base stations, that a channel is clear;
respectively transmitting, by the first group of base stations and/or the second group of base stations, an occupation signal on the CCA and/or eCCA resources respectively negotiated for the first group of base stations and/or the second group of base stations; or, transmitting, by the first group of base stations and/or the second group of base stations, an occupation signal on the entire unlicensed carrier bandwidth resources; and
determining, by the first group of base stations and/or the second group of base stations, subsequent data transmission based on the transmitted occupation signal;
case 2: after the first group of base stations and/or the second group of base stations respectively perform CCA and/or eCCA detection on entire unlicensed carrier bandwidth resources, the method further comprises:
determining, by the first group of base stations and/or the second group of base stations, that a channel is clear; and
after the first group of base stations and/or the second group of base stations detect that the channel is clear, respectively transmitting, the first group of base stations and/or the second group of base stations, an occupation signal on the entire unlicensed carrier bandwidth resources; or, after the first group of base stations detect that the channel is clear, transmitting, by the first group of base stations, an occupation signal on the entire unlicensed carrier bandwidth resources, and when the second group of base stations detect that the channel is not clear, receiving and parsing, by the second group of base stations, the occupation signal transmitted by the first group of base stations.

45. (canceled)

46. The method as claimed in claim 44, wherein the occupation signal transmitted by the first group of base stations and/or the second group of base stations carries at least one of a group identifier, a cell identifier and an operator identifier, and the occupation signal transmitted by the first group of base stations and/or the second group of base stations is in at least one of the following forms:
a Sounding Reference Signal (SRS), a preamble, a Primary Synchronization Sequence/Secondary Synchronization Sequence (PSS/SSS), and a predetermined identifier.

47. The method as claimed in claim 44, wherein before the first group of base stations and/or the second group of base stations transmit the occupation signal on the entire unlicensed carrier bandwidth resources, the method further comprises:
determining, by a first base station in the first group of base stations, that the first base station and a second base station which occupies the entire unlicensed carrier bandwidth resources in advance pertain to base stations subordinate to a same operator; and/or,
determining, by a third base station in the second group of base stations, that the third base station and a fourth base station which occupies the entire unlicensed carrier bandwidth resources in advance pertain to base stations subordinate to a same operator.

48. The method as claimed in claim 47, wherein
when the first base station determines that the first base station and the second base station pertain to base stations subordinate to the same operator, determining, by the first base station, whether a distance between the first base station and the second base station is greater than a first predetermined threshold and/or determining, by the first terminal, whether a signal intensity, received by the first base station, from the second base station is smaller than a second predetermined threshold, if a determination result is positive, transmitting, by the first base station, the occupation signal, and otherwise, not transmitting, by the first base station, the occupation signal; and/or,
when the third base station determines that the third base station and the fourth base station pertain to base stations subordinate to the same operator, determining, by the third base station, whether a distance between the third base station and the fourth base station is greater than a first predetermined threshold and/or determining, by the third terminal, whether a signal intensity, received by the third base station, from the fourth base station is smaller than a second predetermined threshold, if a determination result is positive, transmitting, by the third base station, the occupation signal, and otherwise, not transmitting, by the third base station, the occupation signal.

49. The method as claimed in claim 44, wherein a proportion of the occupation signal to a transmission bandwidth is enabled to be greater than a predetermined proportion by means of at least one of the following manners:
repeating the occupation signal;
scrambling the occupation signal by using at least one of a group identifier, a cell identifier, an operator identifier and other predetermined identifiers;
modifying a value of a subcarrier interval configured for a frequency domain; and
transmitting the occupation signal at two ends of bandwidth frequency domain resources.

50. The method as claimed in claim 42, wherein at least one of a CCA pattern, an eCCA pattern and a data transmission pattern is indicated by pre-scheduling information.

51. The method as claimed in claim 50, wherein at least one of the CCA pattern, the eCCA pattern and the data transmission pattern is of a Physical Resource Block (PRB) level or a Resource Element (RE) level.

52. The method as claimed in claim 44, wherein a pattern of the occupation signal is indicated by pre-scheduling information.

53. The method as claimed in claim 52, wherein the pattern of the occupation signal is of a PRB level or an RE level.

54.-79. (canceled)

80. A data transmission device, applied to a first group of terminals and/or a second group of terminals, the device comprising a hardware processor arranged to execute program modules comprising:
a first detection module, configured to perform Clear Channel Assessment (CCA) and/or evolved CCA (eCCA) detection on unlicensed carrier bandwidth resources by using at least one of the following manners: respectively performing, by the first group of terminals and/or the second group of terminals, CCA and/or eCCA detection on CCA and/or eCCA resources pre-configured for the first group of terminals and/or the second group of terminals; and respectively performing, by the first group of terminals and/or the second group of terminals, CCA and/or eCCA detection on entire unlicensed carrier bandwidth resources, wherein each group of the first group of terminals and/or the second group of terminals comprises one or more terminals; and
a first determination module, configured to determine subsequent data transmission based on a detection result.

81. (canceled)

82. (canceled)

83. A data transmission device, applied to a first group of base stations and/or a second group of base stations, the device comprising a hardware processor arranged to execute program modules comprising:
a second detection module, configured to perform Clear Channel Assessment (CCA) and/or evolved CCA (eCCA) detection on unlicensed carrier bandwidth resources by using at least one of the following manners: respectively performing, by the first group of base stations and/or the second group of base stations, CCA and/or eCCA detection on CCA and/or eCCA resources respectively negotiated for the first group of base stations and/or the second group of base stations; or, respectively performing, by the first group of base stations and/or the second group of base stations, CCA and/or eCCA detection on entire unlicensed carrier bandwidth resources, wherein each group of the first group of base stations and/or the second group of base stations comprises one or more base stations; and
a second determination module, configured to determine subsequent data transmission based on a detection result.

84. (canceled)

85. (canceled)
